(19) United States
(12) Patent Application Publication
(10) Pub. No.: US 2024/0246472 A1
(43) Pub. Date: Jul. 25, 2024

(54) CONNECTED MIXER WITH AUTOMOUS DISCHARGE

(71) Applicant: Oshkosh Corporation, Oshkosh, WI (US)

(72) Inventors: Jacob Holst, Oshkosh, WI (US); Bryan Datema, Rochester, MN (US); Robert Varao, Oshkosh, WI (US); Clint Glunz, Rochester, MN (US); Eric Wall, Oshkosh, WI (US); Brian Scott, Oshkosh, WI (US)

(73) Assignee: Oshkosh Corporation, Oshkosh, WI (US)

(21) Appl. No.: 18/417,826

(22) Filed: Jan. 19, 2024

Related U.S. Application Data
(60) Provisional application No. 63/440,176, filed on Jan. 20, 2023.

(51) Int. Cl. B60P 3/16; B28C 5/42; B28C 7/02; B28C 7/16

(52) U.S. Cl. CPC B60P 3/16; B28C 5/422; B28C 7/024; B28C 7/168

(57) ABSTRACT

A vehicle includes a prime mover, a mixer drum assembly configured to selectively discharge a contents thereof, and a control system having a sensor. The control system is configured to detect, via the sensor, a state of a receiving device that is configured to receive the contents discharged from the mixer drum assembly, determine a desired state of the receiving device, adjust a vehicle state to reduce a difference between the state of the receiving device and the desired state of the receiving device, and cause a presentation of an indication of the adjustment of the vehicle state.

### CROSS-REFERENCE TO RELATED APPLICATION

This application claims the benefit of and priority to U.S. Provisional Patent Application No. 63/440,176, filed Jan. 20, 2023, which is hereby incorporated by reference in its entirety.

### BACKGROUND

The present disclosure relates generally to vehicles. More specifically, the present disclosure relates to mixer discharge control for mixer vehicles.

### SUMMARY

An embodiment relates to a vehicle. A vehicle includes a prime mover, a mixer drum assembly configured to selectively discharge a contents thereof, and a control system having a sensor. The control system is configured to detect, via the sensor, a state of a receiving device that is configured to receive the contents discharged from the mixer drum assembly, determine a desired state of the receiving device, adjust a vehicle state to reduce a difference between the state of the receiving device and the desired state of the receiving device, and cause a presentation of an indication of the adjustment of the vehicle state.

An embodiment relates to a sensing system for a mixing vehicle. The sensing system includes a sensor configured to detect a state of a receiving device configured to receive contents discharged from a mixer drum assembly, and a controller. The controller is configured to determine a desired state of the receiving device, adjust a vehicle state to reduce a difference between the state of the receiving device and the desired state of the receiving device, and cause a presentation of an indication of the adjustment or the state of the receiving device.

An embodiment relates to a method. The method includes discharging contents of a vehicle to a receiving device separate from the vehicle, detecting, by a controller associated with the vehicle, a state of the receiving device, determining, by the controller, a desired state of the receiving device, and generating, by the controller, control signals to reduce a difference between the detected state and the desired state.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1A is a side view of a concrete mixer vehicle, according to an exemplary embodiment;

FIG. 1B is a side view of a concrete mixer vehicle, according to an exemplary embodiment;

FIG. 1C is a side view of a drum assembly of a concrete mixer vehicle, according to an exemplary embodiment;

FIG. 2 is a front perspective view of the concrete mixer vehicle of FIG. 1A, according to an exemplary embodiment;

FIG. 3 is a rear perspective view of the concrete mixer vehicle of FIG. 1A, according to an exemplary embodiment;

FIG. 4 is a perspective view of a piston-type concrete pump, according to an exemplary embodiment;

FIG. 5 is a perspective view of a concrete hopper configured to receive concrete from a mixer truck, according to an exemplary embodiment;

FIG. 6A is a perspective views of a device configured to receive concrete from a mixer vehicle, according to an exemplary embodiment;

FIG. 6B is a perspective views of a device configured to receive concrete from a mixer vehicle, according to an exemplary embodiment;

FIG. 6C is a perspective views of a device configured to receive concrete from a mixer vehicle, according to an exemplary embodiment;

FIG. 7 is a perspective view of a concrete mixer delivering concrete to a hopper via an extender chute, according to an exemplary embodiment;

FIG. 8 is a block diagram of a data processing system, according to an exemplary embodiment;

FIG. 9 is a perspective view of a drum assembly of a mixer vehicle, according to an exemplary embodiment;

FIG. 10 is perspective view of an alerter system, according to an exemplary embodiment;

FIG. 11 is a perspective view of a network diagram for a mixer vehicle, according to an exemplary embodiment; and

FIG. 12 is a flow diagram of a method of controlling a state of a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Mixer vehicles may deliver contents (e.g., pour concrete) at a destination location, or to a receiving device, such as a boom pump, curb machine, power buggy, wheelbarrow, or the like. According to the systems and methods disclosed herein, the mixer vehicle can exchange information with the receiving device. The information can be exchanged to coordinate a state of the mixer vehicle with the receiving device, or a state thereof. The state of the receiving device can include a concrete level in a hopper thereof. For example, the hopper can supply a concrete pump. The state of the mixer vehicle can include a relative position between the mixer vehicle with the receiving device, to include a position of a vehicle chassis (e.g., a relocation of the vehicle, such as a by an autonomous or semi-autonomous system) or a position of a chute of the mixer vehicle (e.g., the position of the chute can be relocated, such as by an autonomous or semi-autonomous system). The state of the mixer vehicle can include a state of the drum assembly, to include a rate of rotation, a direction of rotation, watering, the condition (e.g., slump) of concrete disposed within the mixer vehicle, etc. Such a state may correspond to a rate of concrete delivery to the receiving device. The state of the mixer vehicle can be adjusted to coordinate with the receiving device. For example, a pour rate can be adjusted to prevent overfilling or under filling the receiving device. Advantageously, the adjustment of the state of the mixer vehicle can maintain a supply of concrete to a pump or other element of the receiving device which can prevent an ingress of air to the pump.

The mixer vehicle can include or interface with a user interface. For example, the mixer vehicle can interface with a user interface in the cab of the vehicle, or proximal to a discharge chute of the mixer vehicle. In some embodiments, the user interface may be coupled to the receiving device. For example, the user interface can be a user interface of or integral to the receiving device, or can be selectively coupled thereto. Such a user interface may be communicatively coupled to a controller of the mixer vehicle. For example, the user interface can be communicatively coupled to a controller of the mixer vehicle in network communication with a user interface disposed in the cab of the mixer vehicle.

### Mixer Vehicle

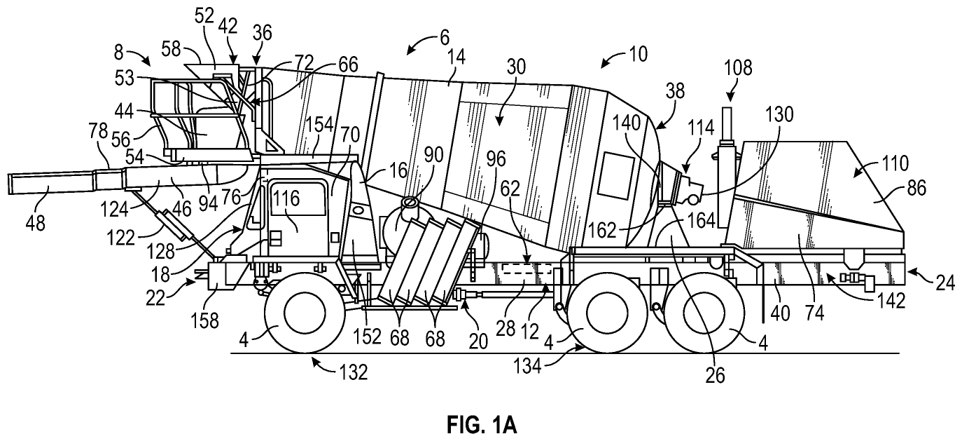

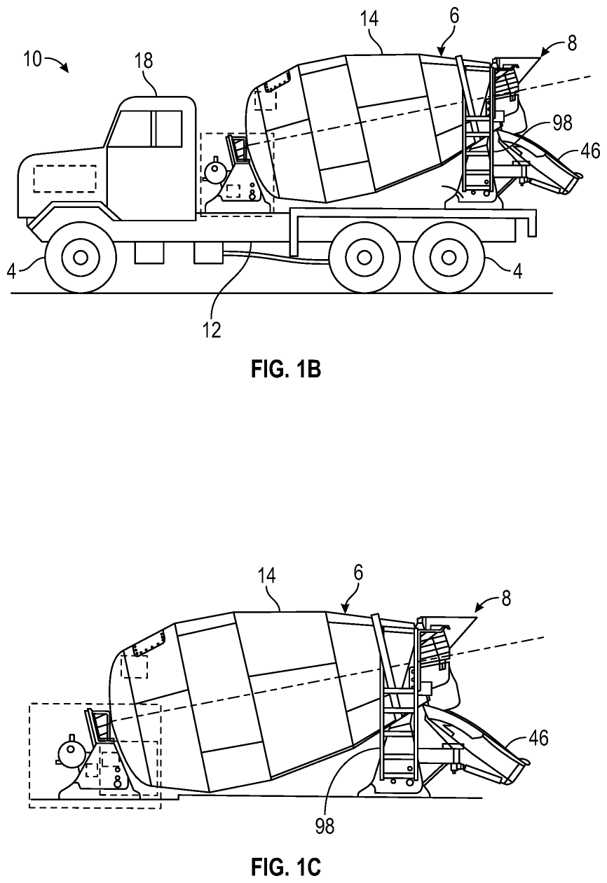

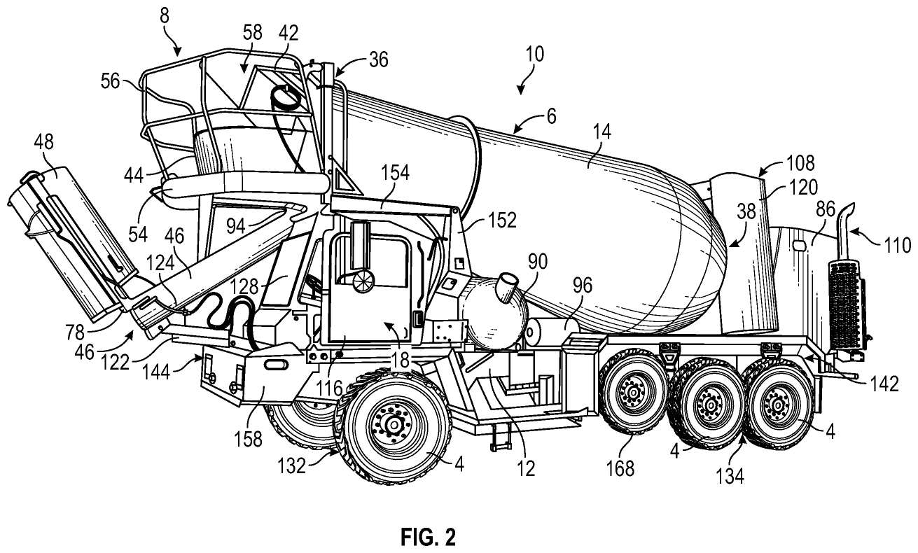

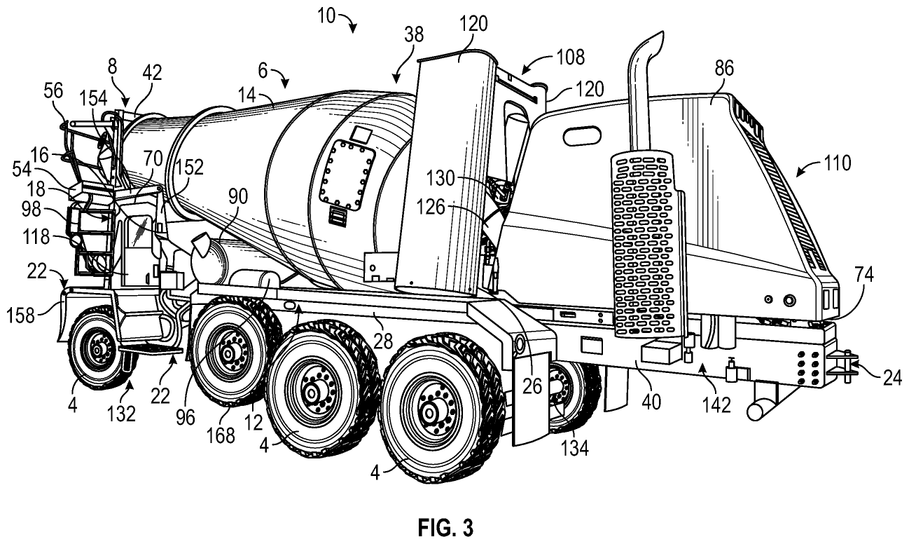

According to the exemplary embodiment shown in FIGS. 1-3, a vehicle, shown as concrete mixer vehicle 10, is configured to transport concrete from a loading location (e.g., a batching plant, etc.) to a point of use (e.g., a worksite, a construction site, etc.). In some embodiments, as shown in FIGS. 1A and 2-3, the mixer vehicle 10 can be a front discharge concrete mixer vehicle. In other embodiments, as shown in FIGS. 1B-1C, the mixer vehicle 10 can be a rear discharge concrete mixer vehicle. The concrete mixer vehicle 10 includes a chassis 12, a drum assembly 6, a hopper assembly 8, a drive system 20, a fuel system 108, and an engine module 110. The concrete mixer vehicle 10 may include various additional engine, transmission, drive, electronic, tractive assembly, braking, steering and/or suspension systems, and hydraulic systems that are configured to support the various components of the concrete mixer vehicle 10. Generally, the chassis 12 supports a mixing drum 14 of the drum assembly 6, a front pedestal 16, a rear pedestal 26, a cab 18, and the engine module 110. Each of the chassis 12, the drum assembly 6, the hopper assembly 8, the drive system 20, the fuel system 108, and the engine module 110 are configured to facilitate receiving, mixing, transporting, and delivering concrete to a job site via the concrete mixer vehicle 10. The references to concrete herein, are intended to be illustrative and non-limiting. For example, references herein to concrete can be substituted with reference to, for example, deliver agricultural feed, landscaping materials, road treatments, refractory materials, or so forth.

The chassis 12 includes a frame 28 that extends from a front end 22 to a rear end 24 of the concrete mixer vehicle 10. Wheels 4 are coupled to the frame 28 and moveably support the frame 28 above a ground surface or road. The wheels 4 may be replaced by other ground engaging motive members, such as tracks. In some embodiments, the chassis 12 includes hydraulic components (e.g., valves, filters, pipes, hoses, etc.) coupled thereto that facilitate operation and control of a hydraulic circuit including a drum drive pump and/or an accessory pump. The frame 28 provides a structural base for supporting the mixing drum 14, the front pedestal 16, the rear pedestal 26, the cab 18, and the engine module 110. In some embodiments, the frame 28 includes a widened front portion that extends over and about the wheels 4 positioned at the front end 22 of the chassis 12 to simultaneously support the cab 18 and serve as a fender for the wheels 4 positioned at the front end 22 of the chassis 12. The frame 28 may include lift eyes or other structures that facilitates lifting along the chassis 12 such that the chassis 12 can be manipulated as a subassembly for assembly and/or maintenance of the concrete mixer vehicle 10. One or more components may be coupled to the chassis 12 using isolating mounts made of a complaint material, such as rubber. The isolating mounts may be configured to reduce the transfer of vibrations between the components and the chassis 12.

The frame 28 includes a pair of frame rails 40 coupled with intermediate cross-members, according to an exemplary embodiment. The frame rails 40 extend in a generally horizontal and longitudinal direction (e.g., extend within 10 degrees of perpendicular relative to a vertical direction, extend within ten degrees of parallel relative to a ground surface when concrete mixer vehicle 10 is positioned on flat ground, etc.) between the front end 22 and the rear end 24. The frame rails 40 may be elongated “C-channels” or tubular members, according to various exemplary embodiments. In other embodiments, the frame rails 40 include another type of structural element (e.g., monocoque, a hull, etc.). In still other embodiments, the frame rails 40 include a combination of elongated C-channels, tubular members, a monocoque element, and/or a hull element. A first frame rail 41 of the frame rails 40 may be disposed along a first lateral side 142 and a second frame rail 43 of the frame rails 40 may be disposed along a second lateral side 144, respectively, of the concrete mixer vehicle 10. By way of example, the first lateral side 142 of the chassis 12 may be the left side of the concrete mixer vehicle 10 (e.g., when an operator is sitting in the cab 18 and positioned to drive the concrete mixer vehicle 10, etc.) and the second lateral side 144 of the chassis 12 may be the right side of the concrete mixer vehicle 10 (e.g., when an operator is sitting in the cab 18 and positioned to drive the concrete mixer vehicle 10, etc.).

The cab 18 is coupled to the frame rails 40 proximate the front end 22 of the chassis 12. According to various embodiments, the cab 18 (e.g., operator cabin, front cabin, etc.) is configured to house one or more operators during operation of the concrete mixer vehicle 10 (e.g., when driving, when dispensing concrete, etc.), and may include various components that facilitate operation and occupancy of the concrete mixer vehicle 10 (e.g., one or more seats, a steering wheel, control panels, screens, joysticks, buttons, accelerator, brake, gear lever, etc.). The cab 18 includes a housing 70 that forms the structure of the cab 18. At least one door 116 is affixed to the housing 70 to allow an operator to enter and exit the cab 18. A windshield 128 is disposed along a front side of the housing 70, near the front end 22, and above a front bumper 158 of the concrete mixer vehicle 10. The windshield 128 is configured to provide visibility to the operator while driving the concrete mixer vehicle 10, operating a main chute 46, and completing other tasks. The front bumper 158 may be affixed to a bottom portion of the housing 70. In some embodiments, the front bumper 158 is affixed to the frame 28 at the front end 22 of the concrete mixer vehicle 10.

A control assembly 76 is disposed within the cab 18 and is configured to control one or more components of the concrete mixer vehicle 10. The control assembly 76 may include controls, buttons, joysticks, and other features that control the movement and orientation of the concrete mixer vehicle 10, the hopper assembly 8, the main chute 46, a charge hopper 42, a discharge hopper 44, the mixing drum 14, and/or other components of the concrete mixer vehicle 10. For example, the control assembly 76 may include overhead controls (e.g., in a forward overhead position) that allow an occupant of the cab 18 to toggle a switch from a ‘Close’ position to an ‘Open’ position to open and close the charge hopper 42 and/or the discharge hopper 44. In some embodiments, the control assembly 76 includes a user interface with a display and an operator input. The display may be configured to display a graphical user interface, an image, an icon, or still other information. In one embodiment, the display includes a graphical user interface configured to provide general information about the concrete mixer vehicle 10 (e.g., vehicle speed, fuel level, warning lights, etc.). The graphical user interface may also be configured to display a current mode of operation, various potential modes of operation, or still other information relating to a transmission, modules, the drive system 20, and/or other components of the concrete mixer vehicle 10.

An air tank 96 is coupled to and supported by the chassis 12 and positioned directly beneath the mixing drum 14. The air tank 96 is configured to store compressed air (e.g., for use in an air brake system, for use when raising and lowering a pusher axle assembly, etc.). A water tank 90 extends laterally across the length of the chassis 12, forward of the air tank 96. The water tank 90 is coupled to the frame rails 40 and positioned beneath the mixing drum 14. The water tank 90 may be used to supply water to wash the concrete mixer vehicle 10 after pouring a concrete load and/or to add water to the concrete within the mixing drum 14 at the construction site and/or during transit, among other uses.

The drum assembly 6 is configured to store, mix and dispense concrete. The drum assembly 6 includes the mixing drum 14, a drum driver 114, and the hopper assembly 8. The mixing drum 14 extends longitudinally along a majority of the length of concrete mixer vehicle 10 and may be angled relative to the frame rails 40 (e.g., when viewed from the side of concrete mixer vehicle 10). The mixing drum 14 has a first end 36 that is positioned toward the front end 22 of the concrete mixer vehicle 10 and coupled to the front pedestal 16 (e.g., support post, support column, etc.). The first end 36 may at least partially extend over the cab 18. The first end 36 defines a drum opening 72 in communication with the hopper assembly 8 through which concrete may flow (e.g., between the charge hopper 42, the mixing drum 14, the discharge hopper 44, the main chute 46, and extension chutes 48, etc.). The mixing drum 14 has a second end 38 that is positioned toward the rear end 24 of the concrete mixer vehicle 10 and coupled to the rear pedestal 26 (e.g., support post, support column, etc.). The mixing drum 14 may be rotatably coupled to front pedestal 16 (e.g., with a plurality of wheels or rollers, etc.) and rear pedestal 26 (e.g., with a drum drive transmission, etc.). Each of the front pedestal 16 and the rear pedestal 26 may be a part of a superstructure of the concrete mixer vehicle 10. The superstructure further includes the frame 28 and the chassis 12. In other embodiments, the mixing drum 14 is otherwise coupled to the frame rails 40.

In another embodiment, the mixer vehicle 10 can include a drum assembly 6 having a different discharge arrangement. For example, the mixer vehicle 10 can include a rear discharge. A rear discharge mixer vehicle 10 can have the mixing drum 14 with the first end 36 positioned toward the rear end 24 of the mixer vehicle 10 and coupled with the rear pedestal 26. The first end 36 can define the drum opening 72 in communication with the hopper assembly 8 through which concrete can flow. In some embodiments, the mixer vehicle 10 can include a ladder 98 that extends down from the side of the hopper assembly 8 to provide access to the first end 36 of the mixing drum 14. The mixing drum 14 can have the second end 38 positioned toward the front end 22 of the mixer vehicle 10 and coupled with the front pedestal 16.

The front pedestal 16 includes an upper portion 152 and a lower portion 154. The upper portion 152 is coupled to and supports the hopper assembly 8. The lower portion 154 is coupled to the frame rails 40 and supports the upper portion 152 of the front pedestal 16 and the first end 36 of the mixing drum 14. The rear pedestal 26 includes an upper portion 162 and a lower portion 164. The lower portion 164 is coupled to the frame rails 40 and supports the upper portion 162. The upper portion 162 supports a bottom interface of a drum drive transmission 140 (e.g., a bottom portion of the housing thereof) and/or the second end 38 of the mixing drum 14. In some embodiments, the rear pedestal 26 includes a pair of legs extending between the frame rails 40 and the drum drive transmission 140.

The drum opening 72 at the first end 36 of the mixing drum 14 is configured to receive a mixture, such as a concrete mixture, or mixture ingredients (e.g., cementitious material, aggregate, sand, etc.) such that the mixture can enter and exit an internal volume 30 of the mixing drum 14. The mixing drum 14 may include a mixing element (e.g., fins, etc.) positioned within the internal volume 30. The mixing element may be configured to (i) agitate the contents of mixture within the mixing drum 14 when the mixing drum 14 is rotated in a first direction (e.g., counterclockwise, clockwise, etc.) and (ii) drive the mixture within the mixing drum 14 out through the drum opening 72 when the mixing drum 14 is rotated in an opposing second direction (e.g., clockwise, counterclockwise, etc.). During operation of the concrete mixer vehicle 10, the mixing elements of the mixing drum 14 are configured to agitate the contents of a mixture located within the internal volume 30 of the mixing drum 14 as the mixing drum 14 is rotated in a counterclockwise and/or a clockwise direction by the drum driver 114.

The drum driver 114 is configured to provide an input (e.g., a torque, etc.) to the mixing drum 14 to rotate the mixing drum 14 relative to the chassis 12. The drum driver 114 may be configured to selectively rotate the mixing drum 14 clockwise or counterclockwise, depending on the mode of operation of the concrete mixer vehicle 10 (i.e., whether concrete is being mixed or dispensed). The drum driver 114 is coupled to a rear or base portion of the second end 38 of the mixing drum 14 and a top end of the lower portion 164 and/or a lower end of the upper portion 162 of the rear pedestal 26. The drum driver 114 includes a transmission, shown as drum drive transmission 140, and a driver, shown as drum drive motor 130, coupled to drum drive transmission 140. The drum drive transmission 140 extends rearward (e.g., toward the rear end 24 of the concrete mixer vehicle 10, toward the engine module 110, etc.) from the second end 38 of mixing drum 14 and the drum drive motor 130 extends rearward from drum drive transmission 140. In some embodiments, the drum drive motor 130 is a hydraulic motor. In other embodiments, the drum drive motor 130 is another type of actuator (e.g., an electric motor, etc.). The drum drive motor 130 is configured to provide an output torque to the drum drive transmission 140, according to an exemplary embodiment, which rotates the mixing drum 14 about a rotation axis. The drum drive transmission 140 may include a plurality of gears (e.g., a planetary gear reduction set, etc.) configured to increase the turning torque applied to the mixing drum 14, according to an exemplary embodiment. The plurality of gears may be disposed within a housing. In some embodiments, a drum drive pump and/or accessory pump may be configured to receive rotational mechanical energy and output a flow of pressurized hydraulic fluid to drive one or more components of the concrete mixer vehicle 10.

The hopper assembly 8 is positioned at the drum opening 72 of the mixing drum 14. The hopper assembly 8 is configured to introduce materials into and allow the materials to flow out of the internal volume 30 of the mixing drum 14 of the concrete mixer vehicle 10. The hopper assembly 8 is configured to prevent loss of material or spillage when the material enters and exits the mixing drum 14. The hopper assembly 8 includes the charge hopper 42, the discharge hopper 44, a hopper actuator 66, a platform 54, and the main chute 46, which, in a front discharge mixer vehicle 10, are positioned above at least partially forward of the cab 18 of the concrete mixer vehicle 10. The charge hopper 42 is configured to direct the materials (e.g., cement precursor materials, etc.) into the drum opening 72 of the mixing drum 14. The discharge hopper 44 is configured to dispense mixed concrete from the internal volume 30 of the mixing drum 14 to the main chute 46 and, ultimately, the desired location.

The platform 54 includes a perforated surface that surrounds the charge hopper 42 and the discharge hopper 44. In some embodiments, the platform 54 includes an asymmetric base. The platform 54 includes platform sides extending beneath the perforated surface. A guardrail 56 is coupled to the platform 54 and follows the contour of a periphery of the platform 54. The platform 54 is situated at a position near the drum opening 72 of the mixing drum 14 to facilitate access by the operator to the drum opening 72, the internal volume 30, the charge hopper 42, the discharge hopper 44, and/or the main chute 46. In some embodiments, the concrete mixer vehicle 10 includes a ladder 98 that extends downward from a side of the platform 54 to allow an operator to climb and reach the platform 54.

The charge hopper 42 includes a first portion 52 that is configured to receive materials during a charging/loading operation. The first portion 52 has a rim 58 (e.g., opening) formed at a free end of the first portion 52. The charge hopper 42 includes a second portion 53 aligned with the bottom of the first portion 52. According to an exemplary embodiment, the charge hopper 42 is selectively repositionable/movable. In some embodiments, the charge hopper 42 is configured to rotate about a horizontal, lateral axis. In some embodiments, the charge hopper 42 is configured to raise and lower vertically. Specifically, the charge hopper 42 is configured to lift, pivot, or otherwise move between a first position (e.g., a lowered position, loading position, a charging position, etc.) and a second position (e.g., a raised position, a dispensing position, a pivoted position, etc.) above or shifted from the first position. In the first position, the charge hopper 42 is configured to direct material (e.g., concrete, etc.) from a source positioned above the concrete mixer vehicle 10 (e.g., a batch plant, etc.) through the drum opening 72 and into the internal volume 30 of the mixing drum 14. The first position may also facilitate transport of the concrete mixer vehicle 10 by lowering the overall height of the concrete mixer vehicle 10. In the second position, the charge hopper 42 moves (e.g., lifts, pivots, etc.) away from the drum opening 72 and facilitates material flowing unobstructed out of the drum opening 72 and into the discharge hopper 44 and the main chute 46.

A hopper actuator 66 is positioned to move the charge hopper 42 between the first position and the second position. The hopper actuator 66 facilitates selectively controlling movement of the charge hopper 42 between the first position and the second position. The hopper actuator 66 is coupled to and extends between the charge hopper 42 and the platform 54. In some embodiments, the hopper actuator 66 is a hydraulic cylinder. In other embodiments, the hopper actuator 66 is another type of actuators (e.g., a pneumatic cylinder, a lead screw driven by an electric motor, an electric motor, etc.).

When receiving the material, the charge hopper 42 may be in the first position and the main chute 46 may be in a first configuration (e.g., a transport configuration, a stored configuration, etc.). Accordingly, material can be deposited into the charge hopper 42, and the charge hopper 42 directs the material into the internal volume 30 of the mixing drum 14 through the drum opening 72. While material is being added to the mixing drum 14, the drum driver 114 may be operated to drive the mixing drum 14 to agitate the material and facilitate fully loading/packing the mixing drum 14. Alternatively, the mixing drum 14 may be stationary while material is added to the mixing drum 14. When discharging and the charge hopper 42 is in the second position, the discharge hopper 44 funnels material from the mixing drum 14 into the main chute 46.

The main chute 46 functions as an outlet of the mixing drum 14 and is used to direct concrete dispensed from the internal volume 30 of the mixing drum 14 and through the discharge hopper 44 to a target location near the concrete mixer vehicle 10. The main chute 46 is pivotally coupled to the platform 54 and/or the discharge hopper 44 such that the main chute 46 is configured to rotate about both a vertical axis and a horizontal axis. The main chute 46 includes a base section 124 that may be pivotally coupled to the platform 54 and/or the discharge hopper 44. An extension chute 48 (e.g., a folding section, a second chute section, etc.) is pivotally coupled to the distal end of the base section 124. In some embodiments, a plurality of extension chutes 48 are pivotally connected to one another. One or more removable/detachable extension chutes 68 may be selectively coupled to the distal end of the extension chute 48.

The main chute 46 is selectively reconfigurable between a first configuration (e.g., a storage configuration, a transport configuration, etc.) and a second configuration (e.g., a use configuration, a dispensing configuration, etc.). In the first configuration, (i) the base section 124 may be selectively oriented substantially horizontal and extending laterally outward, (ii) the extension chute 48 may be selectively pivoted relative to the base section 124 and extending substantially vertically, and (iii) the removable extension chutes 68 may be removed from the extension chute 48 and stored elsewhere in the concrete mixer vehicle 10 (e.g., coupled to the chassis 12 beneath the mixing drum 14, etc.). In the first configuration, the main chute 46 may, therefore, minimally obscure the view of an operator positioned within the cab 18 of a front discharge mixer vehicle 10. In the second configuration, (i) the extension chute 48 may be pivoted relative to the base section 124 from the substantially vertical orientation to a substantially horizontal orientation such that the base section 124 and the extension chute 48 are aligned with one another to form a continuous path through which material can flow, and (ii) one or more of the removable extension chutes 68 may be coupled to the distal end of the extension chute 48 to increase the length of the main chute 46 (e.g., to distribute concrete further away from the concrete mixer vehicle 10, etc.).

A first chute actuator 122 (e.g., a chute raising/lowering actuator, etc.) is coupled to and extends between the main chute 46 (e.g., a distal end thereof, etc.) and the chassis 12. In some embodiments, the first chute actuator 122 is extends between the main chute 46 and the front bumper 158. The first chute actuator 122 is configured to raise and lower the main chute 46 to control the orientation of the main chute 46 relative to a horizontal plane (e.g., the ground, etc.). In some embodiments, the first chute actuator 122 is a pair of opposing hydraulic cylinders. In other embodiments, the first chute actuator 122 is another type of actuator (e.g., a pneumatic cylinder, a lead screw driven by an electric motor, a single hydraulic cylinder, etc.). In some embodiments, the first chute actuator 122 and the main chute 46 are both configured to rotate about the same or substantially the same vertical axis (e.g., as the main chute 46 is pivoted about the vertical axis as described in more detail herein).

A second chute actuator 94 (e.g., a chute pivot/rotation actuator, etc.) is coupled to the base section 124 of the main chute 46 and the platform 54. The second chute actuator 94 is configured to rotate the main chute 46 about a vertical axis. The second chute actuator 94 is configured to move the distal end of the main chute 46 through an arc along the left, front, and right sides of the chassis 12 (e.g., a 150-degree arc, a 180 degree arc, a 210 degree arc, etc.). In one embodiment, the second chute actuator 94 is a hydraulic motor. In other embodiments, the second chute actuator 94 is another type of actuator (e.g., a pneumatic motor, an electric motor, etc.).

A third chute actuator 78 (e.g., a chute folding/unfolding actuator, etc.) is configured to reposition (e.g., extend and retract, fold and unfold, etc.) the extension chute 48 relative to the base section 124 of the main chute 46. The third chute actuators 78 may be coupled to and extend between the base section 124 and the extension chute 48. In some embodiments, the third chute actuator 78 includes a plurality of actuators positioned to reposition a first extension chute 48 relative to the base section 124 and one or more second extension chutes 48 relative to the first extension chute 48. The first chute actuator 122, the second chute actuator 94, and the third chute actuator 78 facilitate selectively reconfiguring the main chute 46 between the first configuration and the second configuration. In some embodiments, a controller (e.g., joystick) is configured to facilitate providing commands to control operation of the first chute actuator 122, the second chute actuator 94, and the third chute actuator 78 to direct the main chute 46 and concrete flow therefrom. In some embodiments, a hopper pump may be coupled to the chassis 12 and configured to provide pressurized hydraulic fluid to power the first chute actuator 122, the second chute actuator 94, and/or the third chute actuator 78. The hopper pump may be a variable displacement pump or a fixed displacement pump. In other embodiments, a pneumatic pump and/or an electrical storage and/or generation device is used to power one or more of the first chute actuator 122, the second chute actuator 94, and/or the third chute actuator 78.

Once at the job site, the concrete mixer vehicle 10 may be configured to dispense the material to a desired location (e.g., into a form, onto the ground, into a receiving device that may be used to relocate the material to a different area of the worksite, etc.). The charge hopper 42 may be repositioned into the second position from the first position by the hopper actuator 66. The extension chute(s) 48 may be extended by the third chute actuator(s) 78 to reconfigure the main chute 46 into the second configuration from the first configuration. An operator can then couple one or more removable extension chutes 68 to the distal end of the extension chute 48 to increase the overall length of the main chute 46 (as necessary). Once the main chute 46 is in the second configuration, the operator can control the first chute actuator 122 and/or the second chute actuator 94 to adjust the orientation of the main chute 46 (e.g., about a vertical axis, about a lateral axis, etc.) and thereby direct the material onto the desired location. Once the main chute 46 is in the desired orientation, the operator can control the drum driver 114 to rotate the mixing drum 14 in the second direction, expelling the material through the drum opening 72, into the discharge hopper 44, and into the main chute 46. The operator may control the speed of the mixing drum 14 to adjust the rate at which the material is delivered through the main chute 46. Throughout the process of dispensing the material, the operator can change the location onto which the material is dispensed by varying the orientation of the main chute 46 and/or by controlling the drive system 20 to propel/move the concrete mixer vehicle 10.

The drive system 20 is configured to propel the concrete mixer vehicle 10 and may drive other systems of the concrete mixer vehicle 10 (e.g., the drum driver 114, etc.). The drive system 20 includes driven tractive assemblies that include a front axle assembly 132 and a pair of rear axle assemblies 134, each coupled to various wheels 4. In some embodiments, the drive system 20 includes a driveshaft coupled to the front axle assembly 132 and/or the rear axle assemblies 134. The front axle assembly 132 and the rear axle assemblies 134 are coupled to the power plant module 62 through the drive system 20 such that the front axle assembly 132 and the rear axle assemblies 134 at least selectively receive mechanical energy (e.g., rotational mechanical energy) and propel the concrete mixer vehicle 10. In some embodiments, a pusher axle assembly 168 (e.g., tag axle assembly, etc.) is configured to be raised and lowered to selectively engage the support surface (e.g., based on the loading of the concrete mixer vehicle 10, etc.). Such a configuration distributes the pressure exerted on the ground by the concrete mixer vehicle 10, which may be required, for example, when traveling through certain municipalities under load.

The power plant module 62 (e.g., prime mover module, driver module, etc.) is configured to supply rotational mechanical energy to drive the concrete mixer vehicle 10. The power plant module 62 is coupled to the chassis 12 and positioned near the longitudinal center of the concrete mixer vehicle 10, beneath the mixing drum 14. According to an exemplary embodiment, the power plant module 62 receives a power input from the engine module 110. In some embodiments, the power plant module 62 includes a transmission and/or an electromagnetic device (e.g., an electrical machine, a motor/generator, etc.) coupled to the transmission. In some embodiments, the transmission and the electromagnetic device are integrated into a single device (e.g., an electromechanical infinitely variable transmission, an electromechanical transmission, etc.). The electromagnetic device is configured to provide a mechanical energy input to the transmission. By way of example, the electromagnetic device may be configured to supply a rotational mechanical energy input to the transmission (e.g., using electrical energy generated from the mechanical power input provided by the engine module 110, etc.). In some embodiments, the power plant module 62 and/or the drive system 20 includes additional pumps (hydraulic fluid pumps, water pumps, etc.), compressors (e.g., air compressors, air conditioning compressors, etc.), generators, alternators, and/or other types of energy generation and/or distribution devices configured to transfer the energy from the power plant module 62 to other systems.

The fuel system 108 is configured to provide fuel to the engine module 110 and/or other components of the concrete mixer vehicle 10. Specifically, the fuel system 108 may be configured to provide fuel to an engine 74 of the engine module 110. The engine 74 may use the fuel in an internal combustion process to generate a mechanical power output that is provided to the power plant module 62 (e.g., to generate electricity, to power onboard electric motors used to at least one of rotate wheel and tire assemblies, to drive the transmission etc.) and/or to power the drum driver 114. The fuel system 108 may include one or more valves, hoses, regulators, filters, and/or various other components configured to facilitate providing fuel to the engine 74. The fuel system 108 includes a container 126 (e.g., a vessel, reservoir, tank, etc.) that is configured to store a fluid (e.g., fuel, air, hydraulic fluid, etc.). The container 126 is disposed behind the drum driver 114 along the chassis 12. In other embodiments, the container 126 is coupled to a side of the rear pedestal 26. In some embodiments, the container 126 is coupled to the chassis 12 and positioned directly beneath the mixing drum 14. According to an exemplary embodiment, the container 126 includes a fuel tank that stores fuel used to power the engine 74. In other embodiments, the container 126 includes an air tank configured to store compressed air (e.g., for use in an air brake system, for use when raising and lowering the pusher axle assembly 168, etc.). In some embodiments, the container 126 includes a hydraulic tank configured to store hydraulic fluid for use in one or more hydraulic circuits (e.g., a hydraulic circuit that includes the drum driver 114, etc.).

A cover assembly 120 including a plurality of cover panels is positioned between the second end 38 of the mixing drum 14 and the engine module 110. The cover assembly 120 is disposed around the fuel system 108 (e.g., the container 126, etc.), the drum driver 114, and the rear pedestal 26. The cover assembly 120 is configured to protect the various internal components from debris. Such debris may be encountered while the concrete mixer vehicle 10 is driven along a roadway, for example. The cover assembly 120 may also protect the various internal components from damage due to collisions with trees, poles, or other structures at a jobsite or while transporting concrete. In some embodiments, all or some of the fuel system 108 is incorporated under a hood 86 of the engine module 110.

The engine module 110 is coupled to the frame rails 40 proximate the rear end 24 of the chassis 12. The engine module 110 is configured to directly, or indirectly, supply the various components of the concrete mixer vehicle 10 with the power needed to operate the concrete mixer vehicle 10. By way of example, the engine module 110 may be configured to provide mechanical energy (e.g., rotational mechanical energy) (i) to one or more components directly (e.g., via a power-take-off, etc.) to drive the one or more components (e.g., a hydraulic pump of the drum driver 114, etc.) and/or (ii) to the power plant module 62 to drive the one or more components indirectly. The engine module 110 may be defined by any number of different types of power sources. According to an exemplary embodiment, the engine module 110 includes the engine 74 coupled to the frame rails 40 and disposed within the hood 86. The engine 74 may include an internal combustion engine configured to utilize one or more of a variety of fuels (e.g., gasoline, diesel, bio-diesel, ethanol, natural gas, etc.) to output mechanical energy. In some embodiments, at least one of the drum drive motor 130, the first chute actuator 122, the second chute actuator 94, and the third chute actuator 78 is electrically driven (i.e., powered using electrical energy) rather than hydraulically driven.

In some embodiments, the engine module 110 includes an energy storage device including a battery module (e.g., batteries, capacitors, ultra-capacitors, etc.). In other embodiments includes multiple battery modules spread throughout the concrete mixer vehicle 10, which cooperate to act collectively as the energy storage device. The engine module 110 can be charged through an onboard energy source (e.g., through use of an onboard generator powered by an internal combustion engine, by operating the electromagnetic device as a generator, during regenerative braking, through an onboard fuel cell, through an onboard solar panel, etc.) or through an external energy source (e.g., when receiving mains power from a power grid, etc.). In some embodiments, the concrete mixer vehicle 10 is a purely electric vehicle that does not include an internal combustion engine and, as such, is driven by electrical energy in all modes of operation. In such embodiments, the concrete mixer vehicle 10 may not include a fuel tank.

### Receiving Devices

The mixer vehicle 10 is configured to deliver concrete to various devices, which may be referred to herein as receiving devices. A subset of receiving devices is disclosed herein. The depicted subset is not intended to be limiting. Indeed, mixer vehicles 10 are configured to deliver concrete to various devices which are not depicted herein. The exemplary devices depicted herein are provided to demonstrate various features of a mixer vehicle 10 or a control system interfacing with the receiving devices. Various features of the devices herein can be substituted, modified, omitted, or added between the various devices provided herein or other devices.

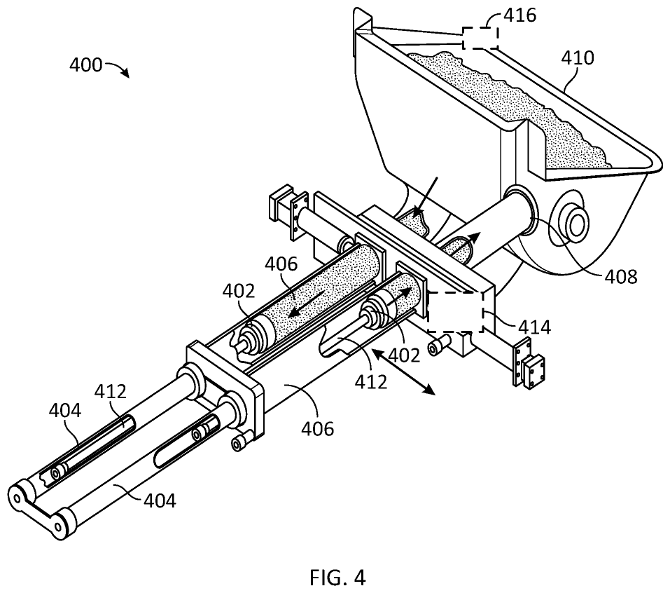

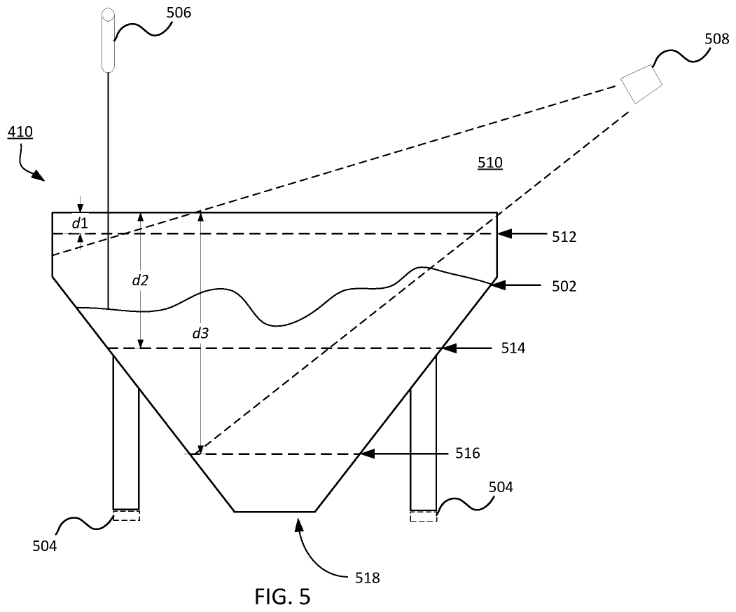

Various receiving devices can include or omit a concrete pump, hopper, or include various variations thereof. For example, a boom pump can include the pump of FIG. 4 and the hopper of FIG. 5. The mixer vehicle 10 can employ the various systems and methods with the boom pump according to the present disclosure to prevent or reduce an ingress of air into the concrete pump, or to alert personnel upon an actual or potential ingress of air into the pump.

### A. Concrete Pump

Referring now to FIG. 4, a piston-type concrete pump 400 is depicted, according to an exemplary embodiment. The concrete pump is configured to receive concrete from the mixer vehicle 10. The concrete pump 400 includes a piston 402. The concrete pump 400 includes a transmitting cylinder 404 configured to transmit energy to the piston 402 to cause a displacement of the piston 402 along a longitudinal axis of a concrete cylinder 406. The lateral displacement can cause contents of the concrete cylinder to be expelled from a discharge port 408 for a first direction of travel piston travel (e.g., an output stroke). For a second direction of piston travel (e.g., an input stroke), the piston 402 travel may draw a contents of a hopper 410 into the concrete cylinder 406. According to some embodiments, the transmitting cylinder 404 can include a hydraulic fluid such that upon a provision of hydraulic fluid or a pressurization thereof, the piston 402 is displaced along the longitudinal axis of the concrete cylinder 406 by a piston rod 412 traversing along a longitude axis shared by the transmitting cylinder 404 and the concrete cylinder 406. Such embodiments are not intended to be limiting. According to various embodiments, the concrete pump 400 may employ electric motors to cause the displacement of the pistons 402. For example, the electric motor can selectively couple with a piston rod 412 via gear teeth of a rotating element of the electric motor, such as via a screw gear.

As depicted, the concrete pump 400 can include multiple transmission cylinders 404 or concrete cylinder 406 pairs. An intake stroke and output stroke can be offset (e.g., by 1800 for two pairs) to maintain a continuous flow of concrete from the hopper 410 into a concrete cylinder 406, and a continuous flow of concrete from a concrete cylinder 406 via the discharge port 408. A mechanical, fluidic, or logical linkage can maintain the inter-cylinder offset. A control system 414 for the concrete pump 400 can impose the logical linkage, or otherwise control, monitor, or convey a status of the concrete pump 400.

The control system 414 can include or interface with at least one sensor 416 to detect a state of a piston 402, piston rod 412, hopper 410 (e.g., fill level), or other portion of the concrete pump 400. The sensor 416 can include a sensor 416 to determine a flow rate of concrete through the concrete pump 400 such as a mass flow sensor. The sensor 416 can include a position or speed sensor for a piston 402, piston rod 412, or the like. The sensor 416 can include a sensor 416 to determine a condition of the contents of the concrete cylinder, such as a slump, water content, or density of concrete, or an of air content or indication thereof. Air can be drawn into the concrete cylinder 406 from the hopper 410 when the concrete level of the hopper falls below the level of the concrete cylinder. Air may then be compressed by the piston 402 and expelled through the discharge port 408. The air may thereafter propel the concrete over personnel or equipment in the area, generate voids in the concrete which may lower a strength or increase a cracking in a finished concrete structure, or otherwise interfere with personnel, equipment, or a concrete pour. The compressed air may further cause hose blowouts, whipping, and the like, which can harm equipment or personnel in the area. The sensor 416 can include a sensor 416 to determine a mass of concrete in the hopper, such as via a force sensor, an optical sensor (e.g., a camera), or a laser sensor, which are further described with regard to FIG. 5. Such a sensor 416 can detect an ingress of air to the concrete cylinder 406. The control system 414 of the concrete pump can be or interface with a control system of a mixer vehicle 10. For example, the various sensors 416 can be coupled to or in network communication with a controller of the mixer vehicle 10. In various embodiments, an element may be referred to as a component of a control system of a receiving device or the mixing vehicle 10. That is, the control system can be coupled with, attributable to, or otherwise associated with the mixer vehicle or the receiving device. For example, the depicted sensors 416 may be referred to as a component of or associated with an associated mixer truck 10.

### B. Hopper

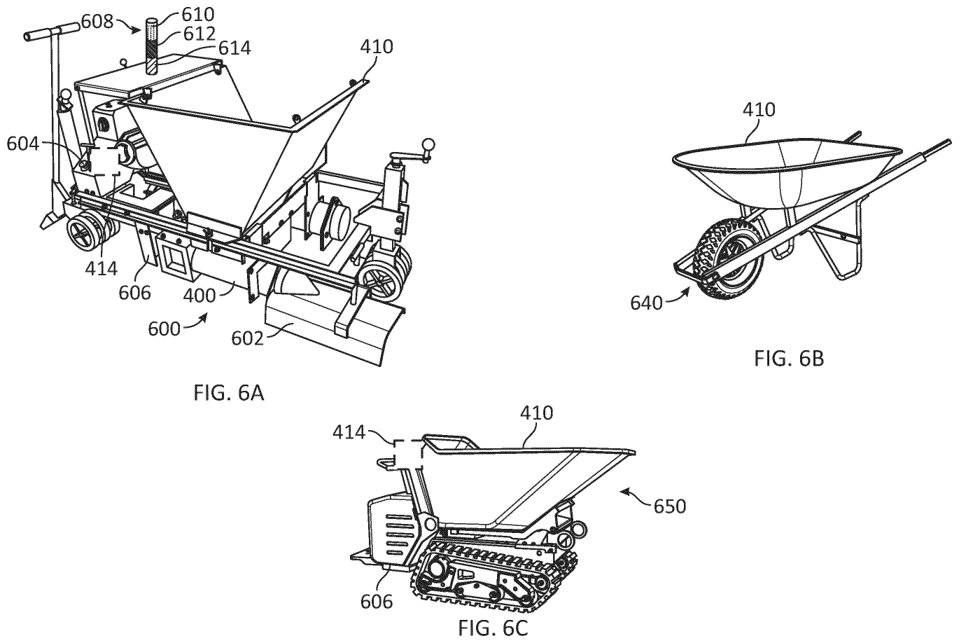

Referring now to FIG. 5, a perspective view of a concrete hopper 410 configured to receive concrete from a mixer vehicle 10 is presented, according to an exemplary embodiment. For example, the hopper 410 can receive concrete from an open upper surface of the hopper, and deliver the concrete to a pump 400 via an outlet 518. Indeed, the hopper 410 may interface with various receiving devices, such as a boom pump comprising the concrete pump 400 of FIG. 4 or the curb machine 600 of FIG. 6. The hopper 410 can maintain a supply of concrete for use by the concrete pump 400 such that pauses or variation of supply from a mixer vehicle 10 do not interrupt the supply of concrete to the mixer vehicle 10. For example, the hopper 410 can maintain a supply of concrete to the concrete pump 400 while transitioning between mixer vehicles 10. Each such mixer vehicle 10 can include a separate control system configured to sense a state of the hopper 410 (e.g., a level of concrete stored therein), or can operatively couple with another sensor 416, such as the depicted time of flight sensor 506 or optical sensor 508.

Concrete can fill the hopper 410 to a concrete level 502. The concrete level 502 can vary along an upper surface, such as according to an irregular or conical surface, or a slope of a sidewall of the hopper 410. The fluid force of the concrete can vary according to the concrete level 502, such that the fluid force of the concrete, in combination with a vacuum formed in the concrete cylinder 406, can fill the concrete cylinder 406 at various rates. Some receiving devices may employ plungers, rams, or other agitators in addition to or instead of the pump which may avoid concrete damming within the hopper 410. Various sensors 416 can detect the concrete level 502 or otherwise infer a quantity of concrete in the hopper 410. Such sensors may detect a sidewall feature of the hopper 410, or determine the level based on a distance to the sensor, a density of the concrete, or the like. The concrete level 502 may be relevant to a maximum operating speed of the concrete pump 400. For example, the concrete pump can run dry and compress ingested air if the level of the pump falls below the outlet 518 of the hopper 410, or may operate at a lower throughput upon a lack of fluid force to supply the hopper 410.

The sensor 416 can detect a concrete level 502 based on a return signal from a time-of-flight sensor 506 such as a laser distance sensor, a LiDAR sensor, acoustic sensors, radar sensor, or the like. The time-of-flight sensor 506 can detect the concrete level 502 along one or more surfaces thereof. For example, the concrete level 502 can be defined according to a maximum, minimum, or average level. A sensor 416 can include an optical sensor 508 (e.g., a camera). The optical sensor 508 can detect a level of the concrete (e.g., a maximum, average, or minimum level) at one or more points along a field of view (FOV) 510 of the optical sensor 508. A force sensor 504 (e.g., a strain transducer) can detect a weight of the contents of the hopper 410, or otherwise determine a quantity or flow rate of concrete through the concrete or a device coupled thereto, such as a concrete pump 400. For example, a force sensor 504 of the concrete pump 400 can determine a quantity of concrete expelled from the concrete cylinder 406, or a series of float switches can define various thresholds. The control systems disclosed herein can adjust a flow rate of concrete responsive to a comparison of a concrete level to said thresholds.

The force sensor 504, and other sensors 416 described herein can include an on board or off board sensor (e.g., integral to the vehicle, receiving device, or selectively operable therewith). According to some embodiments, any of the sensors 416 employed with the hopper 410 can be employed with the drum assembly 6 of the mixer vehicle 10, stationed on the ground proximal to the hopper 410, or along a chute thereof (e.g., the main chute 46, extension chute 48, or the like). For example, the sensors 416 can be integral to the mixer vehicle 10 or the hopper 410. The sensors 416 may be configured to detect a weight, flow rate, level, or other measure of concrete in the mixer vehicle 10, expelled from the mixer vehicle 10, or in a hopper 410 configured to receive concrete from the mixer vehicle 10. Put differently, the control systems described herein can determine a quantity of concrete received in the hopper 410 based on concrete delivered from the mixer vehicle 10, or concrete delivered by the hopper 410 based on concrete received by a device coupled thereto.

The hopper can include or be associated with various threshold levels. For example, the threshold levels can be integral to the hopper, or determined by a controller based on sensor data for the concrete level 502 of the hopper 410. The depicted threshold levels include a first level 512, second level 514, and third level 516. Various hoppers can be associated with various levels (e.g., by a control system). For example, in various embodiments, the threshold levels may be determined, by a controller, based on a weight of the concrete, a time interval of operation of a concrete pump 400, a drum 14, or other source data. For example, the hopper 410 can include an outlet 518 and the threshold can be based on a quantity of material in the hopper 410 between the outlet 518 and the concrete level 502. According to some embodiments, a threshold can vary according to an operational use or phase. For example, a threshold can be increased to receive a maximum amount of concrete prior to a transition between mixer vehicles 10, such that a time to transition the mixer vehicles 10 is increased. At a completion of a project, the threshold can be reduced to reduce excess concrete in the hopper 410 (e.g., according to a rate of use of the concrete, via a device coupled with the hopper 410). For example, the mixer vehicle 10 can reduce rate of delivery of concrete and convey an indication to slow a pump speed such that the pump does not ingest excess air.

### C. Curb Machine

Referring now to FIG. 6A, a perspective view of a curb machine 600 configured to receive concrete from a mixer vehicle 10 is provided, according to an exemplary embodiment. The mixer vehicle 10 can supply concrete to the curb machine 600. The curb machine 600 can employ a concrete pump 400, plunger, ram, or other agitator to deliver concrete received from a mixer vehicle 10 (e.g., via a hopper 410) to an outlet 602 configured to form the concrete into a curb. Other receiving devices can operate similarly, to, for example, form the concrete to a sidewalk or road, or to deliver the concrete to a boom via a pump.

The curb machine 600 can include or interface with a control system 414 including a power interruption contactor 604. The curb machine 600 can include a drive unit 606 to generate tractive effort to propel the curb machine 600. The control system 414 can monitor, control, or otherwise interface with the drive unit 606, the agitator, or various human machine interfaces (HMI) of the curb machine. For example, the HMI may include an audible or visual indicator (e.g., a stack light 608) to display a state of the hopper 410, such as an indication that the concrete level 502 exceeds an upper or lower threshold 612, or is within a desired operating range 610. The HMI may be positioned to be visible to an operator of a mixer vehicle 10 interfacing with the curb machine 600. The control system 414 can determine or convey a location to the mixer vehicle 10, or can interface with the drive system such as to propel the curb machine 600. According to some embodiments, the control system 414 can electronically convey information of one or more sensors or an indication provided via an HMI via network communication. For example, the control system 414 can communicate information between a mixer vehicle 10 and a receiving device. As indicated above, the indication that the concrete is below a lower threshold may indicate a potential affect to equipment or personnel in the area. Accordingly, some indication of a stack light 608 or other HMI can include an indication of such a condition 614 (e.g., ingress of air into a concrete pump 400). The various displays can be color coded such as according to a green-yellow-red scheme, or can vary according to an HMI device (e.g., an alert tone indicative of an ingestion of air into a concrete pump 400, for an audio device). The HMI may include a power interruption contactor 604 to remove power from one or more components of the curb machine, such as the drive unit 606, concrete pump 400, or other component. Such a power interruption contactor 604 or other element of the curb machine 600 can be employed by various receiving devices to remove power from various components thereof.

### D. Wheelbarrow

Referring now to FIG. 6B, a perspective view of a wheelbarrow 640 configured to receive concrete from a mixer vehicle 10 is provided, according to an exemplary embodiment. The wheelbarrow 640 includes a dump hopper 410. The dump hopper 410 may or may not include a separate outlet 602. For example, the wheelbarrow 640 can receive and deliver concrete through a same opening. The capacity of a chute assembly of a mixer vehicle 10 interfacing with the dump hopper 410 may be larger than or commensurate to the capacity of the dump hopper 410 of the wheelbarrow 640. Thus, an operator of the mixer vehicle 10 may employ a chute scraper to control a quantity of concrete delivered to the wheelbarrow 640. The wheelbarrow 640, like other receiving devices, may include or omit (as depicted) a control system 414 which is integral thereto. However, a control system 414 including one or more HMI elements, or sensors 416 can be configured for selective coupling to the wheelbarrow 640 or other receiving device. Further, HMI elements or sensors 416 coupled to the mixer vehicle 10 can convey information relevant to the wheelbarrow 640 to operators proximal to the mixer vehicle 10 (e.g., within visual or audible range). For example, the sensors coupled with the mixer vehicle 10 or the wheelbarrow 640 can detect a concrete level 502 or other information, or the information to the mixer vehicle. HMI coupled with the mixer vehicle 10 or the wheelbarrow 640 can convey indications of, for example, concrete level, air ingestion, relative position, etc. (e.g., to a user interface disposed in the cab 18 of the mixer vehicle 10, a mixer vehicle 10 control system 414, the HMI, or the like).

### E. Power Buggy

Referring now to FIG. 6C, a perspective view of a power buggy 650 configured to receive concrete from a mixer vehicle 10 is provided, according to an exemplary embodiment. The power buggy 650 includes a hopper 410, a control system 414 and a drive unit 606. The hopper can be a dump hopper 410 or include an outlet 602 to deliver concrete another device. The power buggy 650 can include a drive unit 606 to propel the power buggy. The power buggy may include a control system 414 to actuate the drive unit 606. The control system 414 of the power buggy 650 or another control system 414 (e.g., a control system 414 of the mixer vehicle 10) can monitor a concrete level 502, flow rate, or other information of the concrete. The control system 414 can exchange information with the mixer vehicle 10. For example, the information can include a location, heading, or speed of the power buggy 650 relative to the mixer vehicle 10 (e.g., to orient the mixer vehicle 10), the concrete level 502 (e.g., to adjust a rate of concrete delivered to the power buggy), or a threshold quantity (e.g., desired amount, upper bound, or lower bound) or flow rate of concrete (e.g., according to a device identifier of the power buggy 650).

### Mixer Vehicle Autonomous Operation and Alerter System

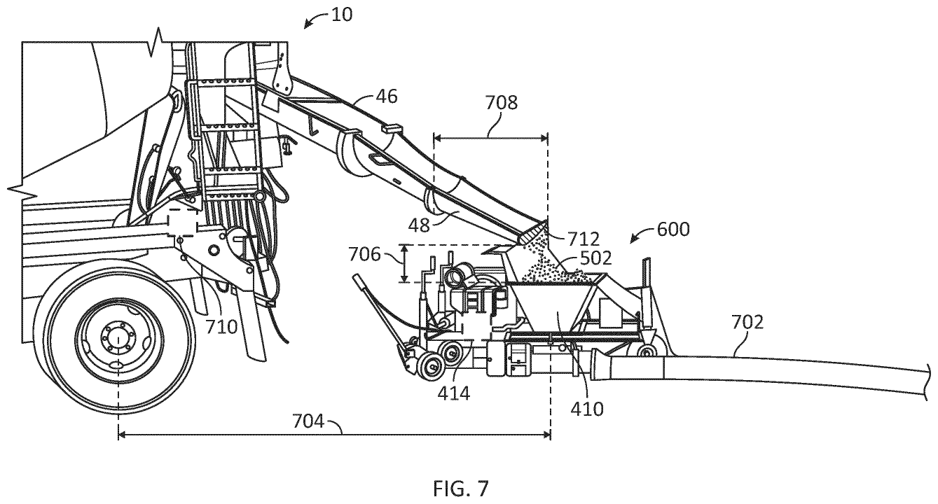

FIG. 7 is a perspective view of a mixer vehicle 10 delivering concrete to a hopper 410, according to an exemplary embodiment. The depicted hopper 410 is a hopper 410 of a curb machine 600 employed to form a curb 702, though the references to the hopper 410 can describe a position of a hopper 410 for other receiving devices according to various embodiments. The mixer vehicle 10 is disposed a lateral distance 704 from a mixer vehicle 10 to a delivery location for a hopper 410 (e.g., a center point thereof). The lateral distance 704 can include a distance along one or more directions, such as along an X axis and a Y axis of a driving surface. A sensor 416 communicatively coupled to the mixer vehicle 10 or curb machine 600 can determine the lateral distance 704 between a delivery location of the hopper 410 and the mixer vehicle 10. The sensor 416 can include an optical sensor 508, time of flight sensor 506, or the like. The sensor 416 can include or couple with a wireless transceiver to communicate between a control system 414 interfacing with the curb machine 600 and a control system 710 of the mixer vehicle 10, which are illustrated as separate systems (e.g., comprising separate processors of one or more controllers), but which may be a same control system 414/710 in some embodiments.

An outlet of the mixer vehicle 10 (e.g., a terminal end of one or more chutes such as an extension chute 48) is disposed over the hopper 410 (e.g., at a center point thereof). According to a relative position of the mixer vehicle 10 and the curb machine 600, the lateral position of the outlet may vary from the center point of the hopper 410, and may extend beyond a threshold distance therefrom (e.g., a threshold distance corresponding to an outer wall of the hopper 410). For example, upon a removal of a terminal extension chute 48, the outlet of the mixer vehicle 10 would extend another lateral distance 708 from the hopper 410.

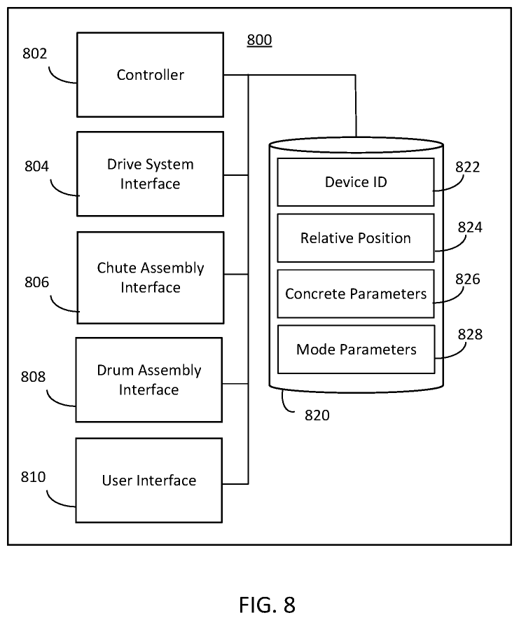

According to the systems and methods disclosed herein, the position of the mixer vehicle 10 or the curb machine 600 can be adjusted to maintain a relative lateral distance 704 therebetween. For example, the control systems 710 interfacing with the mixer vehicle 10 can employ the drive system 20 to drive tractive assemblies of the mixer to maintain a desired distance between the mixer vehicle and the hopper 410. Such operation of the control system 710 can include operation in a follow mode to mirror a heading, direction, or position of a receiving device (e.g., the depicted curb machine 600). The control systems 710 can employ various chute actuators (e.g., the first chute actuator 122, second chute actuator 94, third chute actuator 78, or so forth). For example, the control system 710 can adjust the chute actuators to maintain a relative vertical distance 706 or lateral distance 708 between the mixer vehicle outlet and the hopper 410. Moreover, the control system 710 can adjust a speed of rotation of the drum assembly 6, or otherwise adjust a flow of concrete from the outlet, such as by an actuation of a gate assembly 712 coupled to the extension chute 48. The mixer vehicle 10 control system 710 of FIG. 7 can include, interface with, or be the data processing system 800 of FIG. 8.

Referring now to FIG. 8, a block diagram of a data processing system 800 (also referred to as a sensing system) is depicted, according to an exemplary embodiment. The data processing system 800 can include or interface with at least one controller 802 to execute instructions to employ the systems and methods described herein. The data processing system 800 can include or interface with at least one drive system interface 804 to cause the drive system of the mixer vehicle 10 to cause a displacement of the mixer vehicle 10. The data processing system 800 can include or interface with at least one chute assembly interface 806 to cause the various chute actuators of the mixer vehicle 10 to adjust a terminal end of chutes connected to a drum opening 72 of the mixer vehicle 10. The data processing system 800 can include or interface with at least one drum assembly interface 808 to adjust a speed, tilt, water pump operation, or other element or property of the drum assembly 6 which may cause the contents of the drum assembly 6 to be expelled from the mixing drum 14, or may adjust a property (e.g., slump) thereof. The data processing system 800 can include or interface with at least one user interface 810 to exchange information with a user, such as a driver of the mixer vehicle, operator of a receiving device, or personnel in a vicinity thereof.

The controller 802, drive system interface 804, chute assembly interface 806, drum assembly interface 808, or user interface 810 can each include or interface with at least one processing unit or other logic device such as a programmable logic array engine, or module configured to communicate with a data repository 820 or database. The controller 802, drive system interface 804, chute assembly interface 806, drum assembly interface 808, or user interface 810 can be separate components, a single component, or part of the data processing system 800. The data processing system 800 can include hardware elements, such as one or more processors, logic devices, memories or circuits. The memories can include non-transitory memories storing instructions to cause the execution of the various operations disclosed herein.

The data repository 820 can include one or more local or distributed databases, and can include a database management system. The data repository 820 can include computer data storage or memory and can store one or more of a device identifier (ID) 822, a relative position 824 of the mixer vehicle 10 and a receiving device, concrete parameters 826, and mode parameters 828. The device ID 822 can include an identity of the receiving device. For example, the device ID 822 can include a model number, device type, or the like. The device ID 822 can be received via the user interface 810, such as via manual entry of a user (e.g., for a wheelbarrow 640) or via a message received from a device in network communication with the data repository 820, such as from the receiving device or another mixer vehicle 10. The relative position 824 can include a relative position of the mixer vehicle 10 with respect to a receiving device, such as a distance between a sensor of the mixer vehicle 10, an outlet of the mixer vehicle, and a position of the receiving device such as a desired pouring location in a hopper 410 thereof. For example, the relative position can include the various positions disclosed in FIG. 7. The relative position 824 can further include thresholds, such as a threshold distance (e.g., vertical or lateral distance) between the mixer vehicle 10 and the receiving device. The concrete parameters 826 can include a type, amount, or condition of concrete disposed in the drum 14. The mode parameters 828 can include a parameter for a mode of operation of the mixer vehicle 10. For example, a mode parameter 828 can include a rate of delivery of concrete, a position of an outlet of the mixer vehicle 100 with respect to a receiving device, a concrete form, or another recipient of concrete. A portion of the mode parameters 828 can include a linkage to a device ID 822, such as a rate of concrete delivery associated with a receiving device.

The data processing system 800 can include, interface with, or otherwise utilize at least one controller 802. The controller 802 can include or interface with one or more processors and memory. The processor can be implemented as a specific purpose processor, an application specific integrated circuit (ASIC), one or more field programmable gate arrays (FPGAs), a group of processing components, or other suitable electronic processing components. The processors and memory can be implemented using one or more devices, such as devices in a client-server implementation. The memory can include one or more devices (e.g., random access memory (RAM), read-only memory (ROM), flash memory, hard disk storage) for storing data and computer code for completing and facilitating the various user or client processes, layers, and modules. The memory can be or include volatile memory or non-volatile memory and may include database components, object code components, script components, or any other type of information structure for supporting the various activities and information structures of the inventive concepts disclosed herein. The memory can be communicably connected to the processor and include computer code or instruction modules for executing one or more processes described herein. The controller can include various circuits, software engines, and/or modules that cause the processor to execute the operations of the systems and methods disclosed herein. For example, the controller can generate control signals to effect the various operations disclosed herein as performed by, for example, the controller, the control system, the vehicle, the receiving devices, and so forth.

The controller 802 can include or be coupled with communications electronics. The communications electronics can conduct wired and/or wireless communications. For example, the communications electronics can include one or more wired (e.g., Ethernet, PCIe, or AXI) or wireless transceivers (e.g., a Wi-Fi transceiver, a Bluetooth transceiver, an NFC transceiver, or a cellular transceiver). The controller 802 can cause one or more operations disclosed, such as by employing another element of the data processing system 800. For example, operations disclosed by other elements of the data processing system 800 may be initiated, scheduled, or otherwise controlled by the controller 802.

The data processing system 800 can include, interface with, or otherwise utilize at least one drive system interface 804. The drive system interface 804 can determine a distance or direction (e.g., a vector comprising a distance and direction) between the mixer vehicle 10 and a receiving device having a hopper 410. For example, the distance can be to a fixed portion of the mixer vehicle 10 (e.g., an axle, frame 28, drum opening 72, or the like) or a terminal end of a chute, such as a main chute 46 or extension chute 48 of the mixer vehicle 10. The drive system interface 804 can detect the distance (e.g., a relative position 824) based on a sensor in network communication with the mixer vehicle control system 710. The sensor can be a sensor of a local positioning system, such as an ultra-wideband sensor, a differential-global positioning system sensor, or a Bluetooth transceiver. The sensor can include a time-of-flight sensor 506 coupled to the mixer vehicle 10 or the receiving device or an optical sensor 508 such as a camera system configured to detect a portion of the receiving device. According to some embodiments, the receiving device can include a physical or logical pattern (e.g., QR code, stripe, reflective surface, message header, standard form message, text communique, or the like) configured for operation with the mixer vehicle 10. The pattern can identify a location on the device, a device ID 822, associated mode parameters 828, or properties of the receiving device, such as a hopper capacity or a concrete level 502 threshold. According to some embodiments, the pattern can convey commands. Such commands can include commands to adjust the position of the mixer vehicle 10 or adjust a of flow rate of the mixer vehicle 10 (e.g., to start or stop a flow from the mixer vehicle).

The drive system interface 804 can determine a difference between a detected offset between the mixer vehicle 10 and the concrete receiving device and a desired offset (wherein the desired offset refers to a predefined offset from a sensed location). For example, the drive system interface 804 can determine a distance or direction (e.g., a vector comprising a distance and direction) between the mixer vehicle 10 to reduce the difference. The drive system interface 804 can cause the displacement according to various autonomous or semi-autonomous embodiments. For example, the drive system interface 804 can convey, via the user interface, the difference between the detected and desired offset to an operator of the mixer vehicle 10. The operator may thereafter relocate the vehicle according to operator controls thereof, and the drive system interface 804 can provide an updated difference between the detected and desired offset responsive to a passage of a predefined period of time, distance, or the relocation of the mixer vehicle 10. According to some embodiments, the drive system interface 804 can further evaluate an environment in the path of travel of the mixer vehicle (e.g., by radars, ultrasonics, or other sensors of an advanced driver assistance system (ADAS)). The drive system interface 804 can provide an indication of a detected obstacle, adjust a steering, throttle, or other input to avoid an obstacle present in the environment, or may disengage the tractive effort (e.g., halt the vehicle) with or without input from an operator. In some embodiments, the drive system interface 804 can selectively operate between various modes (e.g., non-autonomous, semi-autonomous, or autonomous modes). For example, the drive system interface 804 can receive a mode of operation from the user interface 810.

In some embodiments, the drive system interface 804 can cause the mixer vehicle 10 to maintain an offset from the receiving device. For example, the receiving device (e.g., a control system 710 thereof or a sensor 416 operatively coupled thereto) can convey a heading, speed, or position to the drive system interface 804, whereupon the drive system interface 804 can cause the mixer vehicle 10 to adjust a position to adjust to heading, speed, or relative position to maintain a relative position between the mixer vehicle 10 and the receiving device.

The drive system interface 804 can convey an indication of a steering, braking or throttle input to the operator of the mixer vehicle 10, via the user interface 810 to cause a displacement of the mixer vehicle 10. For example, the drive system interface 804 can provide a desired speed, throttle position, location, heading, or the like to an operator thereof. According to some embodiments, the drive system interface 804 can include or interface with the fuel system 108, engine module 110, transmission, drive, tractive assembly, braking, steering, or the like to cause a displacement of the mixer vehicle 10. For example, the drive system interface 804 can cause the mixer vehicle 10 to execute the inputs automatically in addition to or instead of providing the inputs to an operator.

According to some embodiments, the drive system interface 804 can limit or inhibit vehicle operation in an autonomous mode. For example, the drive system interface 804 can determine an alertness of a driver (e.g., based on an alerter switch or other operator input, monitoring of a face (e.g., eyes) of an operator, etc. The drive system interface 804 can de-energize all or a portion of the vehicle responsive to a determination that a driver is inattentive. According to some embodiments, the drive system interface 804 can limit a speed, steering angle, or direction of travel of a vehicle during autonomous operation or according to an operator attention. For example, a vehicle can be limited to a speed of not more than two miles per hour (mph), steering angles less than ten degrees per thirty-seconds, and operation in a forward gear. In some embodiments, the drive system interface 804 can enforce geo-fenced locations for autonomous operation. For example, the drive system interface 804 can determine a location of the mixer vehicle 10, compare the location to a predefined list of approved jobsites and engage autonomous operation upon determining that a current location of the mixer vehicle 10 corresponds to an approved jobsite. According to some embodiments, an alerter of the mixer vehicle 10 can indicate a use thereof during, or prior to, autonomous operation. For example, an audible indication can indicate pending autonomous operation to personnel proximate to the vehicle, and a visual indication can indicate the vehicle is operating in an autonomous mode.

The data processing system 800 can include, interface with, or otherwise utilize at least one chute assembly interface 806. The chute assembly interface 806 can control one or more chute actuators to effect a displacement of the terminal end of the mixer vehicle 10. For example, the chute assembly interface 806 can control the first chute actuator 122, the second chute actuator 94, or the third chute actuator 78. The chute assembly interface 806 can determine a location of a receiving device and provide an indication to adjust the chute to align a terminal end of a main chute 46 or extension chute 48 with the receiving device. For example, the chute assembly interface 806 can provide, via the user interface 810, an indication to adjust one or more chute actuators, or may engage one or more chute actuators to adjust a position of the chute. For example, the chute assembly interface 806 can engage the second chute actuator 94 to extend or retract the chutes, or engage the third chute actuator 78 to rotate the chutes towards the receiving device.

The chute assembly interface 806 can interface with sensors 416 to determine a location of the receiving device or any obstacles proximate thereto. For example, the sensors 416 can monitor a front side of a front discharge mixer vehicle 10 or the rear side of a rear discharge mixer vehicle 10. The sensors can be, include, or interface with a sensor of the ADAS system, and may include various optical, time of flight, or other sensors 416. For example, the sensor 416 can include a force sensor to prevent a continued engagement of a chute actuator after collision with an obstacle. The chute assembly interface 806 can determine a future path of the chute assembly, receive sensor data associated with the path, or engage one or more chute actuators responsive to a non-detection of an obstacle based on the sensor data. In some embodiments, the chute assembly interface 806 may process the sensor data based on the future path of the chute assembly, such as by determining if any obstacles are in or proximate to the path (e.g., within 1 meter, 2 meters, or another distance). In some embodiments, the distance can be based on the speed of the chute assembly, or the speed of the chute assembly can be based on the distance of a detected obstacle (e.g., to maintain a constant time-margin to a collision). In some embodiments, the chute assembly interface 806 can process the sensor data based on a current location of the sensor (e.g., based on a distance of an obstacle, a relative speed of an obstacle, or a relative direction of travel of an obstacle). The chute assembly interface 806 can vary an elevation of the chute assembly by engaging a first chute actuator 122. For example, the chute assembly interface 806 can engage the first chute actuator 122 based on a receiving a device ID 822 of a wheelbarrow 640, curb machine 600, or other receiving device to vertically align the terminal end of the chutes with a desired relative vertical location 706.

The chute assembly interface 806 can interface with the drive system interface 804 to coordinate vehicle position. For example, the chute assembly interface 806 can extend the chute to reduce a steering angle or distance traveled of the mixer vehicle 10. The chute assembly interface 806 can exchange a status with the drive system interface 804. For example, upon a disengagement of autonomous operation of the drive system interface 804, the chute assembly interface 806 can receive an indication to disengage any autonomous operation. Upon a detection of an obstacle or a collision with the chute assembly and an obstacle, the chute assembly interface 806 can convey an indication to cause the drive system interface 804 to disengage energy from tractive systems or otherwise halt the mixer vehicle 10.

The chute assembly interface 806 can control a flow rate of concrete from the mixer vehicle 10 according to a vertical position of the chute assembly. For example, the chute assembly interface 806 can raise the chute assembly to slow or arrest a flow of concrete therefrom. The chute assembly interface 806 can interface with the drum assembly interface 808 to control the flow of concrete. For example, the chute assembly interface 806 can raise or lower the chute assembly based on a rotation of the drum 14. According to some embodiments, the chute assembly interface 806 can elevate the chute assembly according to a mode of operation of the mixer vehicle. For example, the operation of the chute assembly can be based on a device ID 822 or mode parameter 828 associated with a receiving device. The chute assembly interface 806 can receive an indication of a corresponding wheelbarrow 640, whereby the chute assembly interface 806 can maintain the chute assembly in a pouring position such that an operator can employ a chute scraper to transfer concrete from the chute to the wheelbarrow 640, or raise the chute between successive wheelbarrow loads to prevent concrete from exiting the chute between loads. The chute assembly interface 806 can actuate a gate assembly 712 to control a flow of concrete from the mixer vehicle 10.

The chute assembly interface 806 can include or interface with an alerter to alert personnel proximal to the chute assembly of a current, impending movement, or another condition such as an ingress of air into a concrete pump 400. For example, the alerter can be a same alerter employed to provide other notifications such as notifications associated with the drive system interface 804. The alerter may be an alerter of the control system 710 of the mixer vehicle 10, or of another device such as a receiving device.

The data processing system 800 can include, interface with, or otherwise utilize at least one drum assembly interface 808. The drum assembly interface 808 can adjust an operation of the drum to adjust a rate of expulsion of the contents of the drum 14. For example, the drum assembly interface 808 can determine a slump or amount of concrete in the drum 14, and select a rate of rotation to cause a discharge at a selected rate. The rate of rotation can thereafter be adjusted to maintain or adjust a flow rate. For example, the drum assembly interface 808 can cause an increase to the rate of rotation as the drum 14 empties to maintain a constant rate of concrete expelled therefrom. The drum assembly interface 808 can receive an indication of a concrete level 502 of a hopper 410, and adjust a rate of rotation to cause an adjustment to the concrete level 502. For example, the drum assembly interface 808 can receive the concrete level 502 from a sensor 416 such as a time-of-flight sensor 506 or optical sensor 508. The drum assembly interface 808 can compare the concrete level 502 to a threshold level, such as a maximum concrete level 502, minimum concrete level 502, or target concrete level 502. The drum assembly interface 808 can adjust the speed of rotation of the drum assembly 6 to adjust the concrete level 502, responsive to the comparison.

The drum assembly interface 808 can receive a threshold from the user interface 810, such as via a user entry or according to a device ID 822 of a receiving device. For example, the drum assembly interface 808 can determine or select a threshold based on a device type or hopper capacity. The drum assembly interface 808 can include sensors to determine a concrete level 502 in the hopper 410, or receive such data and adjust a delivery of concrete based thereupon. The drum assembly interface 808 can further receive various sensor data associated with a concrete pump 400 such as an air fraction of the concrete cylinder 406, a piston 402 speed or position, or the like. Thus, the drum assembly interface 808 can detect conditions indicative of an adjustment to the flow rate of the concrete, and adjust the flow based thereon. The drum assembly interface 808 can transition between various modes of operation based on an interfacing device. The drum assembly interface 808 can convey an indication to the chute assembly interface based on a selected mode, which may correspond to an interfacing device. For example, the drum assembly interface 808 can selectively elevate a chute assembly for some receiving devices, and maintain the chute assembly position for other receiving devices.

The drum assembly interface 808 can provide an indication to the user interface 810, of the remaining contents of the drum 14. For example, sensor data from a force sensor, camera, laser, LiDAR, radar, or other sensor can be employed, by the controller 802, to determine the contents of the drum 14, the slump of the drum, or other concrete parameters 826, and may convey the concrete parameters 826 to the user interface 810 for presentation. The force sensor 504 can include a sensor 416 coupled to the drum driver 114. The drum assembly interface 808 can exchange information with further devices in network communication therewith, such as a batching plant to determine an amount of concrete or constituent components delivered to the drum 14 or another mixer vehicle 10 to coordinate a pouring handoff.

The data processing system 800 can include, interface with, or otherwise utilize at least one user interface 810. The user interface 810 can convey information to an operator of the mixer vehicle 10 disposed in a cab 18 of the mixer vehicle, personnel proximal to the drum opening 72 of the mixer vehicle 10, or remote from the mixer vehicle 10 (e.g., via a tablet, mobile application interface, or other display of the user interface 810). The user interface 810 can convey information to a user of a receiving device, such as via a control system 414 of the receiving device or via a lighted signal or an alerter speaker of the user interface 810 (e.g., bell, horn, or electrodynamic transducer). The user interface 810 can depict textual, graphic based, spoken voice, tonal, or other information, and may convey information through messaging to interfacing devices including the receiving device or a cab indicator of the mixer vehicle 10. The user interface 810 can depict any information exchanged, stored, or accessible to any node in network communication therewith such as a quantity of concrete in a mixer drum 14, a slump of concrete, a mixing time until a drum 14 can deliver concrete, etc. Various instances of the user interface 810 can depict information according to a graphical user interface 810 including various views, access controls, or display types.

In some embodiments, the user interface 810 can generate a depiction (e.g., a grid) of the receiving device, relative to the mixer vehicle 10. The grid can overlay an image including a real-time image (e.g., rear view camera of the mixer vehicle). The grid or other depiction can depict a desired pour location on the hopper 410 of the receiving device according to a symbolic representation. The grid or other depiction can display a mixer vehicle 10 location which may include a chute assembly location. The grid or other depiction may include a range of motion or distance between various elements. For example, the grid or other depiction can depict an arc of travel for the chute assembly. The operator can adjust the location of the mixer vehicle 10 (which may include the chute assembly) to align the output of the mixer vehicle 10 with the hopper 410 of the receiving device.

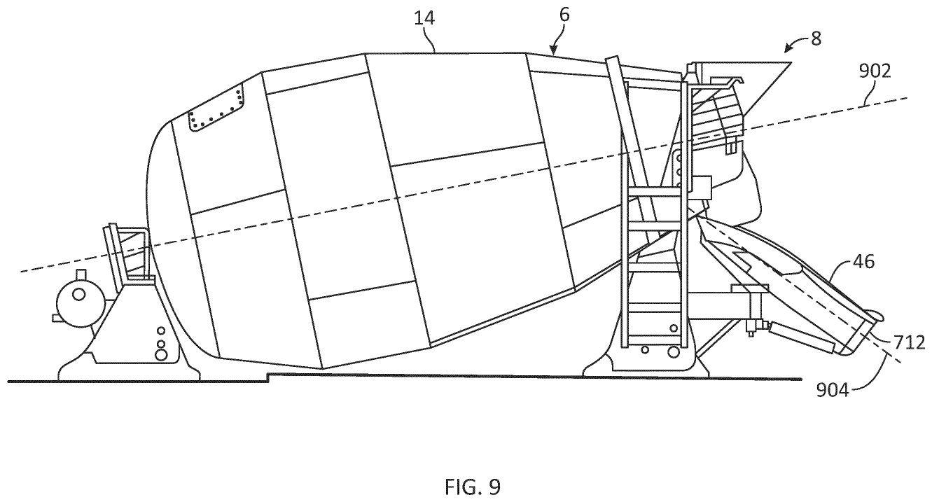

Referring now to FIG. 9, a drum assembly 6 is depicted, according to an exemplary embodiment. The drum assembly 6 can include a drum 14 comprising a spiral screw disposed therein such that the concrete can transit from an input of the drum assembly 6 to an outlet thereof, via the drum opening 72. A rate of concrete flow from the drum 14 can depend on a composition of the concrete (e.g., a water content/slump, aggregate content, etc.), and a quantity of concrete within the drum 14. The rate of concrete flow can depend on a geometry of the drum 14 and the spiral screw thereof, as well as a rotational speed of the drum 14. The rate of concrete flow can depend on an orientation of the drum 14, such as an angle of elevation 902 of the drum 14. The rate of concrete flow along the main chute 46 and any extension chutes 48 can depend on an angle 904 thereof, drum speed, and the composition of the concrete. In some embodiments, the drum assembly interface 808 can receive a flow rate from a sensor 416 disposed within the drum 14 or configured to detect the flow of concrete moving along the chute and/or through a drum opening of the drum (e.g., a paddle wheel, optical sensor 508, etc.). For example, the sensor may be configured to determine an angle of the chute (e.g., an inlet angle from the drum opening to the chute, and outlet angle of the chute relative to the receiver, etc.). The rate of flow can be adjusted by modifying the chute angle 904, changing drum speed, or by repositioning a gate assembly 712 of the chute, such as a variable flow gate having various positions.

As described above, an in drum sensor 416 and/or chute sensor 416 positioned or directed toward the chute can determine an entry or exit angle of concrete from the drum 14. The drum assembly interface 808 can determine a quantity or property of concrete based on the entry or exit angle. For example, for each drum geometry and RPM, the data processing system 800 can correlate entry or exit angles with the flow rate of the concrete to predict or adjust flow rates. However, such a flow rate may vary according to a composition of concrete, an ambient environment, temperature, and the like. Moreover, a geometry of a spiral screw may vary along a longitudinal dimension thereof, and thus it may be advantageous to determine an entry angle to a center of a drum, or an angle of the concrete from the center of the drum to the drum opening 72. In some embodiments, the in-drum sensor can determine the entry time to the bottom of the drum, bottom to exit time or angle, angle to the bottom of the drum, etc. Further, in at least some embodiments, determining a time for the transit of concrete through the drum 14 or a portion thereof may increase a granularity of a detection based on variations in rotational speed relative to a speed sensor of the drum assembly 6. In some embodiments, the slump sensor may be a force sensor configured to detect a force conveyed by a mechanical, hydraulic, or electrical system, or the like. In some embodiments, the slump sensor may comprise a speed sensor including a vision system or other optical system (e.g., camera), laser, radar, etc. Any of the in-drum sensors can be employed to detect a flow rate of concrete outside of the drum (e.g., along an exposed chute of the mixer vehicle 10 such as the depicted main chute 46).

According to some embodiments, the drum assembly interface 808 can receive a fill volume from a sensor of the mixer vehicle 10, a user input via the user interface 810, or via network communication from a concrete batch plant. According to some embodiments, the drum assembly interface 808 can receive a quantity or flow rate received from another device. For example, a curb machine 600 or other paving machine can provide a linear distance completed which may correspond to a known volume of concrete according to a selected geometry of the curb machine 600.

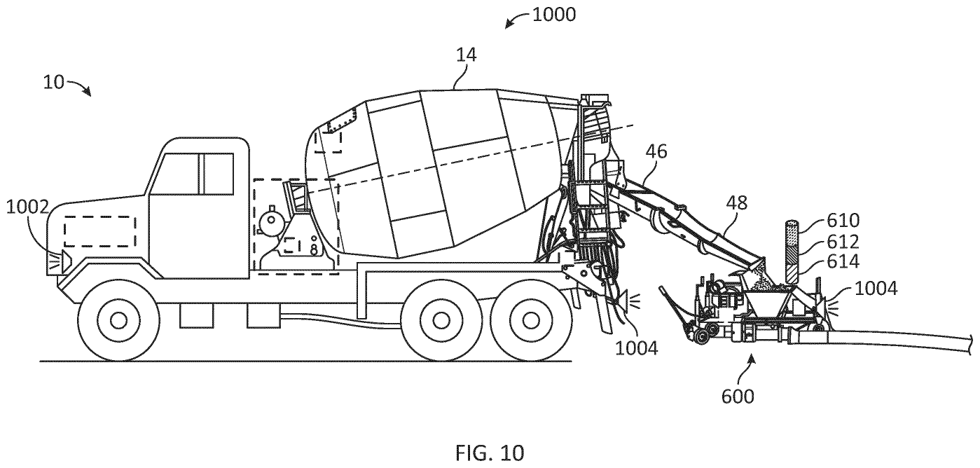

Referring now to FIG. 10, a perspective view of an alerter system 1000 is provided, according to an exemplary embodiment. Although the depicted embodiment includes a curb machine 600, the alerter system 1000 can include or interface with various receiving devices such as a boom pump, wheelbarrow 640, power buggy 650, etc. References to the curb machine 600 are not intended to be limiting. Some receiving devices include a control system 414 in network communication with a control system 710 of the mixer vehicle 10, a control system 414 not in network communication with control system 710 of the mixer vehicle, or may not include a control system 414. Some receiving devices include sensors of the mixer vehicle 10 control system 710 operatively coupled thereto, such as a sensor selectable coupled with a wheelbarrow. Such selective coupling can include magnetic coupling, bolted coupling, etc.

The alerter system 1000 can include audible or visual alerts to convey information between a mixer vehicle 10 or an operator thereof and any operators of a receiving device. The audio or visual devices can include speakers, lights (e.g., stack lights, refectory beacon lights, a portion of a GUI of a user interface 810, or a cab 18 indicator). The audio or visual devices can be in network communication with a controller 802 of the mixer vehicle 10. For example, the audio or visual devices can include a horn 1002 of the mixer vehicle 10. The audio or visual devices can include devices proximal to a discharge location of the mixer vehicle 10 (e.g., a front of a front discharge mixer vehicle 10 or a rear of a rear discharge mixer vehicle 10). For example, an alerter speaker 1004 can be coupled to the mixer vehicle 10 or the curb machine 600.

The audio or visual devices can be configured to convey information from the hopper 410 to the mixer vehicle 10 or an operator thereof. For example, the audio or visual devices can include a light coupled to the hopper to convey a concrete level 502 to the operator of the mixer vehicle 10, such as an overflow or underflow warning (e.g., based on a comparison to a corresponding threshold), or an indication to maintain or adjust a current flow rate. Such a device may also alert personnel proximal to the hopper to an ingestion of air into a pump 400, or a deviation of a concrete level 502 from a threshold. According to some embodiments, the audio or visual devices can include a device disposed inside the cab 18 of the mixer vehicle 10 to convey the information to the operator thereof. As indicated above, audio or visional devices mechanically coupled to the mixer vehicle 10 or curb machine 600 can alert personnel to a movement of the mixer vehicle 10 (e.g., a tractive system thereof, chute assembly thereof, etc.).

The data processing system 800 can cause an alert (e.g., a tone, spoken voice, or alerter bell) to provide an alert upon a deviation of a concrete level 502 from one or more thresholds (e.g., an upper or lower threshold). A local indication of the hopper 410 can provide a visual indicator of the concrete level relative to one or more thresholds. The various indications of a concrete level 502 can include various indications in addition to or instead of the concrete level 502. Such indications can include an indication of air detected in a concrete cylinder 406 (e.g., by a force sensor), an impending or current movement of the mixer vehicle 10 or the curb machine 600. Such indications can include an unexpected concrete level 502 responsive to a rotation rate of a drum (e.g., based on a filling rate that is faster or slower than expected, by a threshold amount). For example, a slower filling rate than expected can be indicative of future pressurized air in the pump or an indication to substitute the mixer vehicle 10, or increase a rate of rotation of a drum 14 thereof.

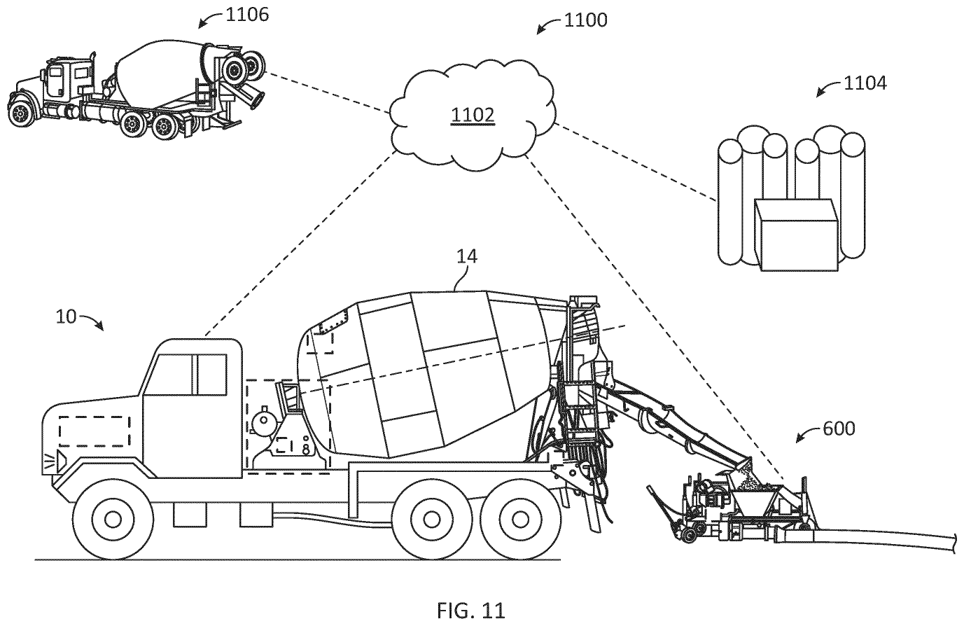

Referring now to FIG. 11, a network diagram 1100 for a perspective view of a system comprising the mixer vehicle 10 of FIG. 1 is provided. A network 1102 joins the various elements of the system. Each network connected device may connect to one or more further network connected device at a time. For example, the depicted network connections may be contemporaneous (e.g., via a cellular network or wide area network) or cumulative over a time interval via various local area networks. Each device of the network can be in network communication with further devices of the network. As used herein, network communication refers to a communicative connection with additional devices such as via a network interface (e.g., Wi-Fi, CAN, or LIN) or a point-to-point interface (e.g., USB or RS-232) with another controller having a network interface. Various network connections can include unidirectional, bidirectional, broadcast, and other message types.

The network 1102 can include a connection between the mixer vehicle 10 and a batching plant 1104. For example, the mixer vehicle 10 can exchange information with the batching plant 1104 incident to a receipt of concrete therefrom. For example, the mixer vehicle 10 can receive an indication of a content of material delivered to the drum (e.g., concrete parameters 826 such as a composition of aggregate, cement, quantity, or the like). The network 1102 can include various further network connections, such as network connections with an operations center (not depicted) to manage the various mixer vehicles 10, batching plants 1104, and other connected devices. The operations center can include an instance of the user interface 810 depicting any of the information exchanged, stored, or accessible to any node in network communication therewith. The network 1102 can include a connection between the mixer vehicle 10 and a receiving device, such as a pump boom, paving machine, or the depicted curb machine 600. For example, the network 1102 can exchange information related to a hopper volume, pump operation, or relative or absolute position of the mixer vehicle 10 or the receiving device. The information can include a concrete level 502 or a threshold associated therewith, or a command or other indication to adjust an operation of a pump (e.g., to avoid running dry), the drum assembly 6 (to maintain a constant supply of concrete), or other data associated with the systems and devices disclosed herein. The network communication can include a location or status of a mixer vehicle 10 or receiving device relevant to an autonomous or semi-autonomous system.

The network 1102 can exchange information between the mixer vehicle 10 and an additional mixer vehicle 1106. For example, the mixer vehicle can convey a device ID 822, a flow rate of concrete or other concrete parameter 826, or a selection of a mode associated with a device ID 822 to the additional mixer vehicle 1106. Such communications may reduce a variance between concrete received from various mixer vehicles, minimize a changeover time between vehicles, and otherwise manage the delivery of concrete. For example, the respective mixer vehicles 10, 1106 can communicate an amount of concrete disposed therein, such that an additional mixer vehicle 1106 can begin concrete watering, attachment of extension chutes, or other preparations to deliver concrete to a receiving device.

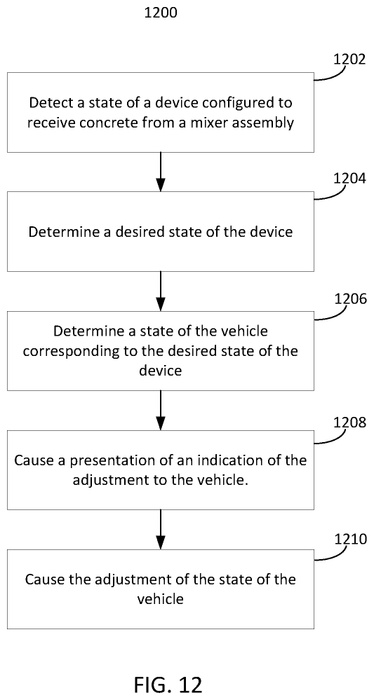

Referring now to FIG. 12, a flow diagram of a method 1200 of controlling a state of a vehicle is presented, according to an exemplary embodiment. The method 1200 may be employed to adjust a state of a mixer vehicle 10 to interface with a receiving device. For example, the method 1200 may be employed to adjust a position or rate of concrete delivery of the mixer vehicle 10 to a receiving device including a pump (e.g., a pump boom). The method 1200 is disclosed as a non-limiting example; additional operations may be provided before, during, or after the various operations of the method 1200. Further, some operations may only be described briefly herein, however, the operations may be performed in conjunction with other methods, such as those disclosed herein.

In brief summary, a data processing system 800 detects a state of a receiving device at operation 1202. At operation 1204, the data processing system 800 can determine a desired state of the device. At operation 1206, the data processing system 800 determines a state of the vehicle corresponding to the desired state of the receiving device. At operation 1208, the data processing system 800 can cause a presentation of an indication of the adjustment to the vehicle. The data processing system 800 can cause the adjustment of the state of the vehicle at operation 1210.

Referring again to operation 1202, the data processing system 800 can detect a state of a receiving device. The state can refer to or include a location of the receiving device such as an absolute or relative location (e.g., with reference to the mixer vehicle 10). The state can refer to or include a condition of a hopper of the receiving device, such as a concrete level 502 thereof, or a difference between the concrete level and a threshold. The state can refer to or include a rate of concrete employed by the receiving device, or a speed, air ingestion, or other condition of a concrete pump 400 or other agitator. The state can refer to or include a detection of an ingestion of air into a pump, an actuation of a power interruption contactor 604 or loss of operative connection with a receiving device (e.g., a loss of visual contact of an optical sensor 508, or a loss of operative connection of a wireless transceiver).

At operation 1204, the data processing system 800 can determine a desired state of the receiving device. The desired state can refer to a user or system selected value (e.g., nominal operating value). For example, with respect to a slump, the desired state can include a nominal water content; with respect to a distance, the desired state can include a nominal vertical and horizontal offset for a receiving device location. Such a location may correspond with the operation of the receiving device. For example, if the receiving device is a boom pump, the desired location may be a location configured to deliver concrete to a destination (e.g., a concrete form). The location can be a relative location, such as a relative location to the mixer vehicle 10 or a portion thereof. For example, the location can be relative to a sensor or emitter of the mixer vehicle 10 (e.g., an ultra-wideband transceiver) or a terminal end of a chute assembly of the mixer vehicle 10 to receive concrete therefrom. The desired state can include a rate of concrete received by the receiving device, or a desired concrete level 502 of a hopper 410 of the receiving device. Further desired states can refer to various predefined values or ranges stored in a memory device, received via a user interface, or otherwise available to the data processing system, such as according to an association with a device ID 822 of a receiving device.

At operation 1206, the data processing system 800 can determine a state of the vehicle corresponding to the desired state of the device. For example, the state of the vehicle can be a location of a mixer vehicle 10 or a portion thereof relative to the receiving device. Such a state can include the location of a portion of the vehicle coupled to a frame 28 or a movable portion of the vehicle (e.g., a chute assembly). A state of the mixer vehicle 10 may correspond to the delivery of concrete therefrom. For example, the state of the mixer vehicle 10 can include a rate of rotation of the drum assembly 6, a concrete parameter of the concrete (e.g., a slump thereof which can be modulated according to an engagement of a water pump). In some embodiments, such as a detection of a relative location between the mixer vehicle and a receiving vehicle, at least a portion of operations 1202 and 1206 can be coextensive with each other, and may be performed prior or subsequent to other operations, such as operation 1204. Indeed, no sequence need be inferred from the operations disclosed herein. In various embodiments, operations can be performed in various sequences, including iteratively, such as a control loop including at least some of the disclosed operations.

At operation 1208, the data processing system 800 can cause a presentation of an indication of the adjustment to the vehicle. For example, the presentation can be via a user interface 810 such as via an indication to an operator of a mixer vehicle 10 in the cab 18 of the mixer vehicle 10. The presentation of the indication can be delivered via a control system 414, 710 of the receiving device or the mixer vehicle 10. The presentation of the indication can be delivered via an audio or visual signal proximate to a receiving device. The presentation can include an alert of an impending adjustment to the location of the mixer vehicle (e.g., based on the tractive effort of the mixer vehicle 10 or a displacement of the chute assembly). In some embodiments, the presentation can be a presentation to prompt a user to execute an adjustment, or confirm that an adjustment be made prior to executing the adjustment. In some embodiments, the indication can be a prompt that the adjustment will be executed automatically, and may further include a command element (e.g., button) to prevent such execution. The presentation can further include an indication that an adjustment will not be made, such as wherein the adjustment would be a relocation of the vehicle, where autonomous operation is not supported (e.g., because of an obscured sensor, a detected obstacle, or a geofence restriction). Wherein an adjustment includes multiple constituent portions (e.g., vehicle movement and an adjustment of a drum speed), the various adjustments can be presented according to a same or different manner, or such presentation can be omitted for one or more portions. For example, a drum speed adjustment can be performed automatically, and a chute position adjustment can be prompted for user confirmation, via the user interface 810.

At operation 1210, the data processing system 800 can cause the adjustment of the state of the vehicle. The adjustment can include a relocation of the mixer vehicle 10 employing the prime mover thereof. Such a relocation can include a relocation of the vehicle chassis 12 or the chute assembly, by various chute actuators. Causing the adjustment can include presenting a recommended input to an operator of the mixer vehicle 10 or an autonomous operation of the mixer vehicle 10. Causing the adjustment can include receiving, from a sensor, an indication of whether an obstacle exists in a path of the adjustment and executing the adjustment responsive to a determination that the obstacle does not exist or delaying an adjustment responsive to the detection of the obstacle. The adjustment can include an adjustment to the drum assembly 6. For example, the data processing system 800 can adjust the rotational speed or direction of the drum assembly 6. The data processing system 800 can adjust the slump of concrete via an actuation of a watering system, or drum rotation. The data processing system 800 can adjust the rate of delivered concrete which may, in turn, adjust a concrete level 502 of the receiving device.

Various descriptions, herein, make use of the word “or” to refer to plurality alternative options. Such references are intended to convey an inclusive or. For example, various data processing system 200 components herein are referred to as hardware or software components. Such a disclosure indicates that the components may comprise a hardware component, a software component, or both a hardware and software components.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the mixer vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle comprising:
a prime mover;
a mixer drum assembly configured to selectively discharge a contents thereof; and
a control system, comprising a sensor, configured to:
detect, via the sensor, a state of a receiving device configured to receive the contents discharged from the mixer drum assembly;
determine a desired state of the receiving device;
adjust a vehicle state to reduce a difference between the state of the receiving device and the desired state of the receiving device; and
cause a presentation of an indication of the adjustment of the vehicle state.

2. The vehicle of claim 1, wherein:
the desired state of the receiving device comprises a level of concrete; and
the adjustment to the vehicle state comprises adjusting a flow rate of concrete therefrom.

3. The vehicle of claim 2, wherein, to adjust the flow rate of concrete, the control system adjusts a rotational speed of the mixer drum assembly.

4. The vehicle of claim 2, wherein, to adjust the flow rate of concrete, the control system instructs a chute actuator to adjust a position of a chute assembly.

5. The vehicle of claim 1, wherein:
the desired state of the receiving device comprises a relative location between the receiving device and the vehicle; and
the adjustment to the vehicle state comprises an adjustment to the relative location of a terminal end of a chute assembly at a hopper of the receiving device.

6. The vehicle of claim 5, wherein, to adjust the relative location, the control system instructs a chute actuator to adjust a position of the chute assembly.

7. The vehicle of claim 5, wherein, to adjust the relative location, the control system instructs the prime mover to a move the vehicle.

8. The vehicle of claim 1, wherein:
the state of the receiving device comprises a concrete level indicative of air ingestion into a concrete pump; and
the control system is configured to provide a visual indication of the concrete level indicative of air ingestion.

9. A sensing system for a mixing vehicle, comprising:
a sensor configured to detect a state of a receiving device configured to receive contents discharged from a mixer drum assembly;
a controller configured to:
determine a desired state of the receiving device;
adjust a vehicle state to reduce a difference between the state of the receiving device and the desired state of the receiving device; and
cause a presentation of an indication of the adjustment or the state of the receiving device.

10. The sensing system of claim 9, wherein:
the desired state of the receiving device comprises a level of concrete; and
the adjustment to the vehicle state comprises adjusting a flow rate of concrete therefrom.

11. The sensing system of claim 10, wherein:
the state of the receiving device comprises an air ingested into a concrete pump; and
the presentation of the indication comprises an audible alert.

12. The sensing system of claim 10, wherein, to adjust the flow rate of concrete, the controller generates control signals to engage a chute actuator to adjust a position of a chute assembly.

13. The sensing system of claim 9, wherein:
the desired state of the receiving device comprises a relative location between the receiving device and the mixing vehicle; and
the adjustment to the vehicle state comprises an adjustment to the relative location of a terminal end of a chute assembly at a hopper of the receiving device.

14. The sensing system of claim 13, wherein, to adjust the relative location, the controller engages a chute actuator to adjust a position of the chute assembly.

15. A method for operating a vehicle, the method comprising:
discharging contents of a vehicle to a receiving device separate from the vehicle;
detecting, by a controller associated with the vehicle, a state of the receiving device;
determining, by the controller, a desired state of the receiving device;
generating, by the controller, control signals to reduce a difference between the detected state and the desired state.

16. The method of claim 15, further comprising:
presenting, via a user interface, an indication of the adjustment of the vehicle state; and
receiving, from the user interface, a confirmation of the adjustment, wherein the control signals to reduce the difference between the detected state and the desired state are generated responsive to the receipt of the confirmation.

17. The method of claim 16, wherein:
the desired state of the receiving device comprises a quantity of contents stored thereby; and
the adjustment to the vehicle state comprises adjusting a flow rate of the contents.

18. The method of claim 17, wherein adjusting the flow rate comprises:
adjusting a rotational speed of a mixer drum assembly.

19. The method of claim 17, wherein adjusting the flow rate comprises:
engaging a chute actuator to adjust a position of a chute assembly.

20. The method of claim 16, wherein:
the desired state of the receiving device comprises a relative location between a hopper of the receiving device and a terminal end of a chute assembly the vehicle; and
the adjustment to the vehicle state comprises an adjustment to the terminal end of the chute assembly.
